(19) United States
(12) Patent Application Publication
(10) Pub. No.: US 2017/0278192 A1
(43) Pub. Date: Sep. 28, 2017

(54) Systems and Methods for Performing Financial Related Modeling

(71) Applicant: JPMorgan Chase Bank, N.A., New York, NY (US)

(72) Inventor: James PEARD, Cary, IL (US)

(21) Appl. No.: 14/743,098

(22) Filed: Jun. 18, 2015

Related U.S. Application Data
(63) Continuation of application No. 12/575,536, filed on Oct. 8, 2009, now abandoned.
(60) Provisional application No. 61/103,797, filed on Oct. 8, 2008.

(51) Int. Cl. G06Q 40/06

(52) U.S. Cl. CPC G06Q 40/06

(57) ABSTRACT

The invention provides a computer implemented method and system for performing financial calculation processing for a user. The method may include the steps of: presenting the user with a plurality of financial calculations for selection using a computer interface; inputting a selected financial calculation from the user; presenting the user with an interface to input data associated with the selected calculation; determining which data is input from the user; determining processing to perform in response to which data is entered by the user; invoking at least one calculation portion, such that the at least one calculation portion performs the determined processing; generating results based on the determined processing; and outputting the results to the user. Various other features are described.

### RELATED PATENT APPLICATION

This application claims priority to U.S. Provisional Patent Application 61/103,797 filed Oct. 8, 2008, the content of which is incorporated herein by reference in its entirety.

### BACKGROUND OF THE INVENTION

Financial calculators and other manners of modeling financial data are known. In particular, financial calculators are available on the Web for a wide variety of financial scenarios, including retirement, other savings, mortgages, and car loans, for example.

Known calculators, and other financial models, input various data from a user of the calculator. Typically the input includes monetary amounts such as a starting amount, amount intended to be input periodically over a period of time, and target amounts, such as a target amount desired to be attained at a given point in time.

### BRIEF SUMMARY OF THE INVENTION

The invention provides a computer implemented method and system for performing financial calculation processing for a user. The method may include the steps of: presenting the user with a plurality of financial calculations for selection using a computer interface; inputting a selected financial calculation from the user; presenting the user with an interface to input data associated with the selected calculation; determining which data is input from the user; determining processing to perform in response to which data is entered by the user; invoking at least one calculation portion, such that the at least one calculation portion performs the determined processing; generating results based on the determined processing; and outputting the results to the user. Various other features are described.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a high level flowchart showing a financial model process, in accordance with one embodiment of the invention.

FIG. 2 is a flowchart showing further details of the “perform processing for user, including inputting request and inputting data to process request” of FIG. 1, in accordance with one embodiment of the invention.

FIG. 3 is a flow chart showing in further detail the “input any additional data (from available resources) in response to request from user” step of FIG. 2, in accordance with one embodiment of the invention.

FIG. 4 is a flowchart showing in further detail the “based on data obtained, determine what calculations are available to be processed for the user” step of FIG. 2, in accordance with one embodiment of the invention.

FIG. 5 is a flow chart showing in further detail the “data check module performs final check of entered data (e.g. is data complete to allow processing of request)” step of FIG. 1, in accordance with one embodiment of the invention.

FIG. 6 is a flow chart showing in further detail the “calculation governing module performs life expectancy probability processing (to determine a life expectancy that is needed for desired processing)” step of FIG. 1, in accordance with one embodiment of the invention.

FIG. 7 is a flowchart showing in further detail the “calculation governing module performs mathematical processing of request (i.e., effect calculation run of the desired processing)” step of FIG. 1, in accordance with one embodiment of the invention.

FIG. 8 is a flowchart showing in further detail the “selected calculation processing portion is invoked” processing of FIG. 7, in accordance with one embodiment of the invention.

FIG. 9 is a flowchart showing in further detail the “selected calculation processing portion performs the needed computation on the selected data, and generates resultant data” step of FIG. 8, in accordance with one embodiment of the invention.

FIG. 10 is a flowchart showing further details of the “calculation governing module processes results of the calculation run” step of FIG. 1, in accordance with one embodiment of the invention.

FIG. 11 is a flowchart showing further details of the “assign grade to the results of the request, or respective grades to components of the request” step of FIG. 10, in accordance with one embodiment of the invention.

FIG. 12 is a flowchart showing in further detail the “assign grade parameters based on retrieved data” step of FIG. 11, in accordance with one embodiment of the invention.

FIG. 13 is a flowchart showing further details of the “prepare results of processing for output to the user” step 900 of FIG. 1, in accordance with one embodiment of the invention.

FIG. 14 is a block diagram showing a processing system with financial calculation system, in accordance with one embodiment of the invention.

FIG. 15 is a diagram showing further data that might be obtained from the user, in accordance with one embodiment of the invention.

FIG. 16 is a diagram showing illustrative user profile data, in accordance with one embodiment of the invention.

FIG. 17 is a diagram showing the plotting of various retirement disbursements, in accordance with one embodiment of the invention.

FIG. 18 is a diagram showing the growth and decline of assets, as the person, i.e., the user, approaches and draws away from the date of retirement, in accordance with one embodiment of the invention.

FIG. 19 is a diagram showing the spenddown of assets, in accordance with one embodiment of the invention.

FIG. 20 is a table showing various projections as generated by the financial calculation system, in accordance with one embodiment of the invention.

FIG. 21 is a retirement scorecard (showing probability of running out of assets) generated by the financial calculation system in accordance with one embodiment of the invention.

FIG. 22 is a retirement scorecard (showing grades for retirement readiness) generated by the financial calculation system in accordance with one embodiment of the invention.

FIG. 23 is a diagram showing results of retirement demand (longevity) and retirement supply (retirement resources) comparison processing, in accordance with one embodiment of the invention.

FIG. 24 is a table showing aspects of retirement readiness relating to measuring the implicit forces, actions and reactions that may be in play, in accordance with one embodiment of the invention.

FIG. 25 is a table showing a case study in accordance with one embodiment of the invention.

FIG. 26 is a graph of the median life expectancy of a 50 year old man at different retirement ages, in accordance with one embodiment of the invention.

FIG. 27 is a graph of the median number of years a “supply” of wealth will last at different retirement ages, in accordance with one embodiment of the invention.

FIG. 28 is a further graph comparing supply and demand in accordance with one embodiment of the invention.

FIG. 29 is a graph showing aspects of probability of success relating to demand, in accordance with one embodiment of the invention.

FIG. 30 is a graph showing aspects of probability of success relating to retirement supply, in accordance with one embodiment of the invention.

FIG. 31 is a graph showing the plotting of the adjusted demand curve and supply curve, in accordance with one embodiment of the invention.

### DETAILED DESCRIPTION OF THE INVENTION

Hereinafter, aspects of financial calculation systems in accordance with various embodiments of the invention will be described. As used herein, any term in the singular may be interpreted to be in the plural, and alternatively, any term in the plural may be interpreted to be in the singular.

While financial calculators are known, such calculators have their shortcomings. For example, known calculators are not readily adaptable to utilization of varying amounts and nature of data. Also, known calculators are limited in their ability to provide relatively quick answers based on relatively limited information. The invention addresses such shortcomings of known models.

The invention relates to a financial model, and in particular to a financial calculator for processing retirement related financial data. The processing of the invention is readily adaptable to varying data, in terms of both the particular parameters that are used in the processing, as well as the nature of the data.

More specifically, the invention relates to a financial model, and in particular to a financial calculator for processing retirement related financial data that an individual can use in the planning of personal finances. The processing of the invention is readily adaptable to varying data, in terms of both the particular parameters that are used in the processing, as well as the nature of the data. For example, the model is readably adaptable to use of estimates in planning, such as estimates of assets available. In response, the model provides a rich output.

The invention provides a variety of features The model of the invention provides relatively sophisticated answers in a relatively short period of time, with limited information. Estimates may be used, and then amounts tightened up as the analysis progresses.

In accordance with one embodiment of the invention, the tool allows one to assess their financial health as they approach retirement. For example, it provides analysis to help one choose a safe retirement age, while factoring in all sources of assets, investment types and vehicles (after tax or qualified), other sources of income, tax rates and applicable taxation of investments, marital status, desired retirement lifestyle, annuity options, different order of asset spenddown, and health considerations. It captures and quantifies the various risks—such as living too long, poor asset performance, and unexpected health costs.

In accordance with one embodiment of the invention, the model is developed for internet access, and provides easy input and rich display of results, so that the process is not cumbersome, but is instead iterative and educational.

Other features are provided. Varying inputs to the user's savings may be considered such as annuity or lump some payments. Contributions and other aspects of planning with a spouse may be considered by the model. Other related parameters may be considered by the model, including tax information, health, long term care, post retirement income, budgeting and asset return.

The model may be pre-populated to a degree, with such information as date of birth, compensation, income, income and other particulars of a spouse, as well as other information. Such information may be loaded in, as well as further information regarding when retirement is desired and the desired “standard of living” desired during retirement years.

In response, the model provides age dependent, i.e., age triggered analysis, based on the various information that is provided. The model of the invention provides a grade, e.g., A, B, . . . F, depending on the information provided. In particular, the grade may typically vary over what desired ages are desired. As the user enters a higher age of intended retirement, the grade might well improve. Further, the grade may vary based on what assets are pulled from and the particular order of pulling from assets.

In conjunction with the model generating such grades, for providing an understanding of the user's retirement situation (or other financial situation), the model also generates and utilizes probabilities. In particular, the invention works with the probabilities of life expectancy. In the analysis, post retirement years of a person may be divided into four periods of time, for example. Chance of living 25 years is 50%, chance of living 35 years is 25%, and chance of living 40 years is 1%. Such probabilities are then used in conjunction with other data, such as assets and draw down of those assets.

Accordingly, the invention provides for analysis across different assets. For example, the invention allows manipulation of which assets are spent down first in a retirement plan and other manners in which those assets are manipulated.

The invention may typically be used by a user via a website. Accordingly, the invention would be disposed on a suitable server and accessed over the Internet. However, various other arrangements may be employed, such as with the software of the invention locally disposed on the user's computer.

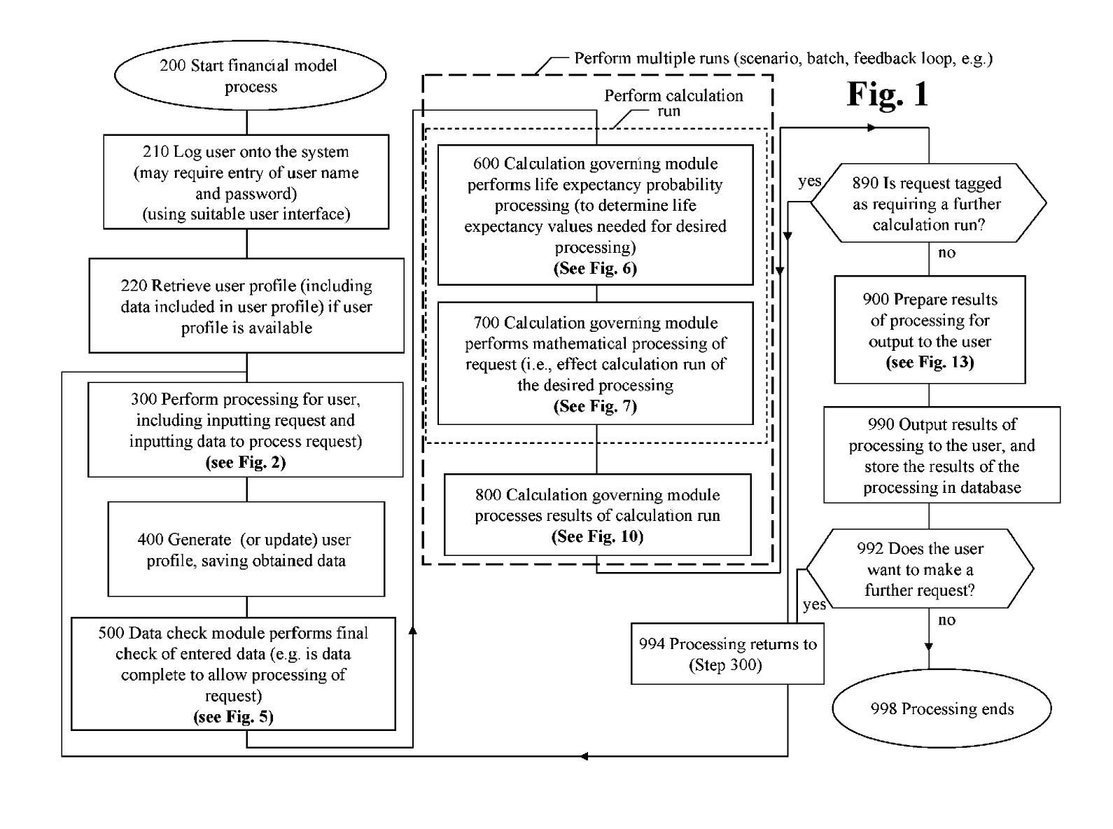

FIG. 1 is a high level flowchart showing a financial model process, in accordance with one embodiment of the invention.

In accordance with one embodiment of the invention, the process starts in step 200 and passes to step 210. In step 210, the user is logged onto the system. For example, such log-on may require entry of a user name and password. Further, such log-on may be performed using a suitable user computer with user interface, for example. After step 210, the process passes to step 220.

In step 220, the system, based on the user name and password (or other suitable identifying information), retrieves the user profile (including data included in user profile) if user profile is available. Thus, for example, if it is the first time that the particular user is working on the system, then there will be no user information previously stored, i.e., there will be no user profile. After step 220, the process passes to step 300.

As otherwise described herein, it is appreciated that user data and generated results may be saved, updated and compared over periods of time as desired. Thus, for example, the results from a January 2008 session might be saved, and later compared to the results in an October 2008 session, in accordance with embodiments of the invention.

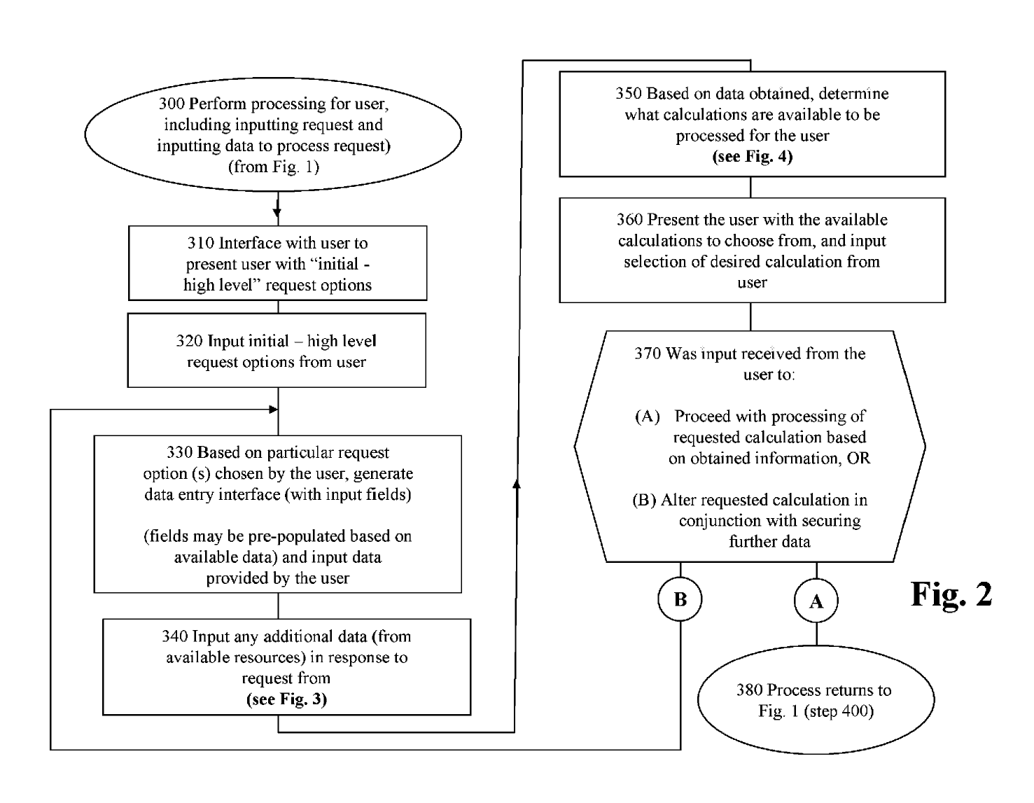

In step 300 of FIG. 1, the system performs a variety of processing for the user, including inputting request information from the user, as well as inputting data to process requests of the user. Further details of the processing of step 300 are shown in FIG. 2.

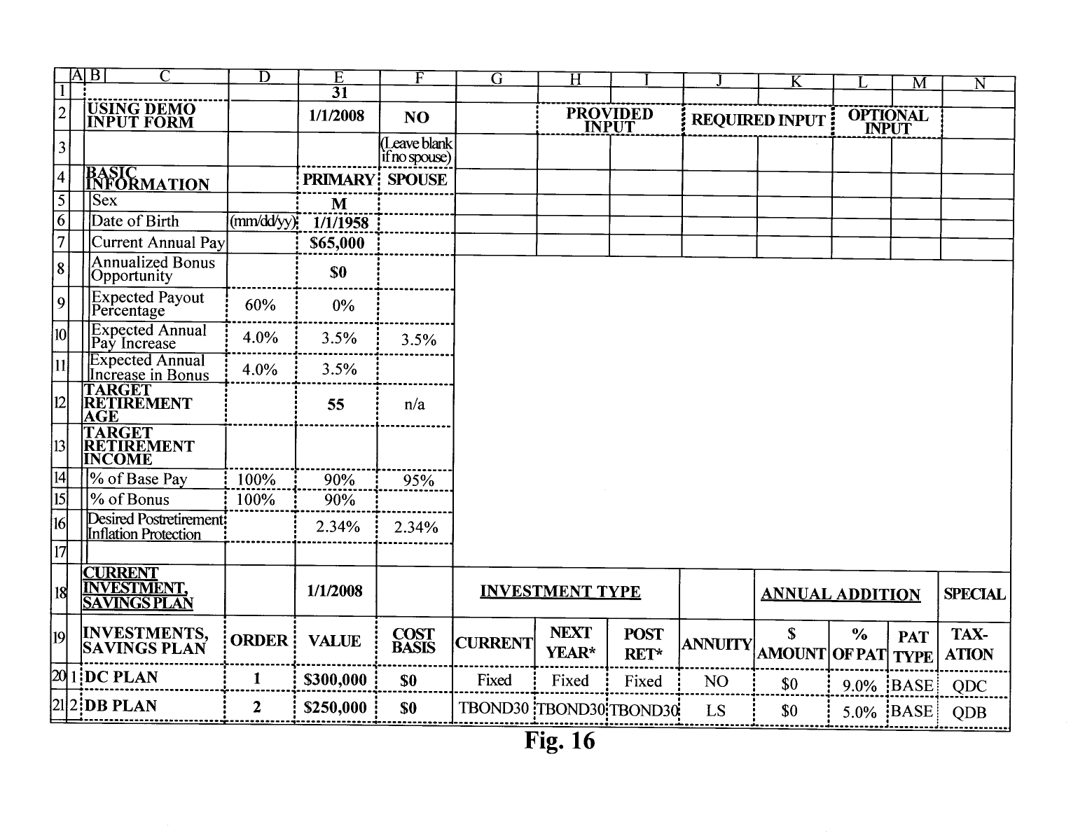

After step 300, the process passes to step 400. In step 400, the processing generates a user profile, if a user profile has not previously been generated, i.e., it is the first time that the user has been on the system, or alternatively the system updates the user profile, if indeed a user profile has previously been generated. FIG. 16 is a diagram showing illustrative user profile data, in accordance with one embodiment of the invention. For example, user profile information may include personal information, expected pay, expected pay increases, target retirement age, target retirement income, savings in respective plans, as well as various other information.

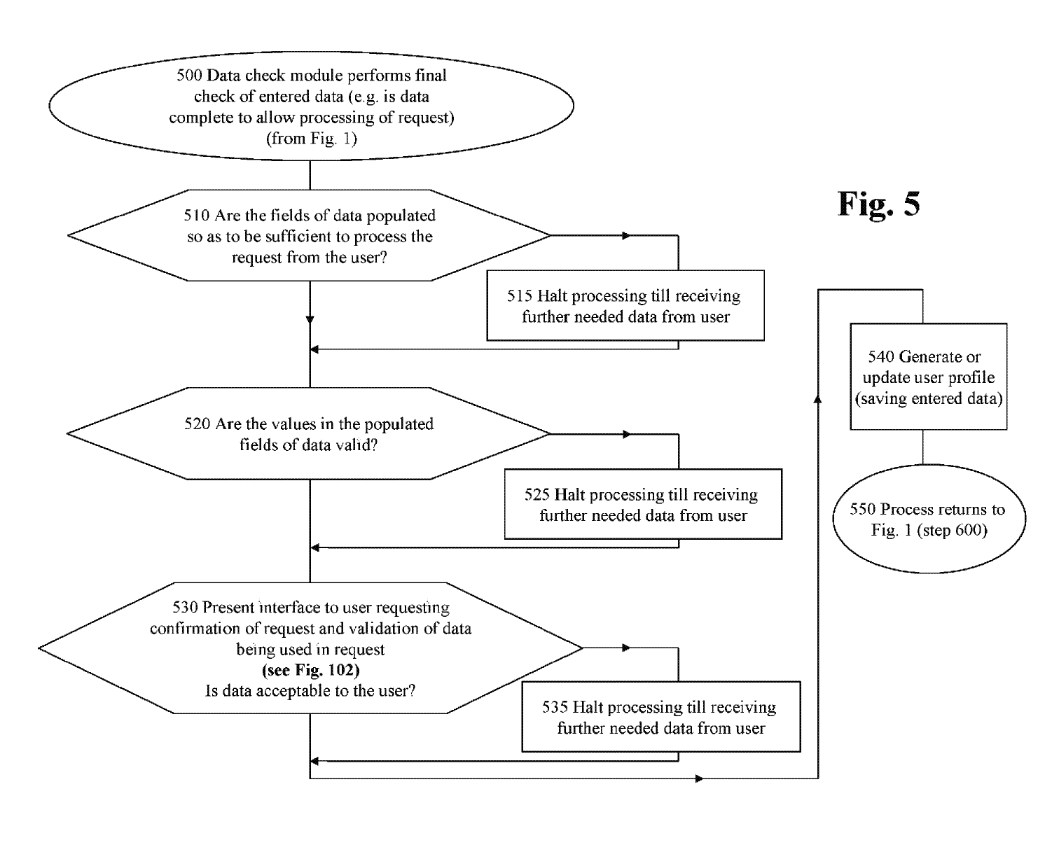

After step 400 of FIG. 1, the process passes to step 500. In step 500, the processing, and specifically the data check portion 110, performs a final check of data that has been entered by the user. In other words, is the data sufficient to allow processing of the request that the user has requested. Further details of the processing of step 500 are shown in FIG. 5. After step 500, the process passes to step 600.

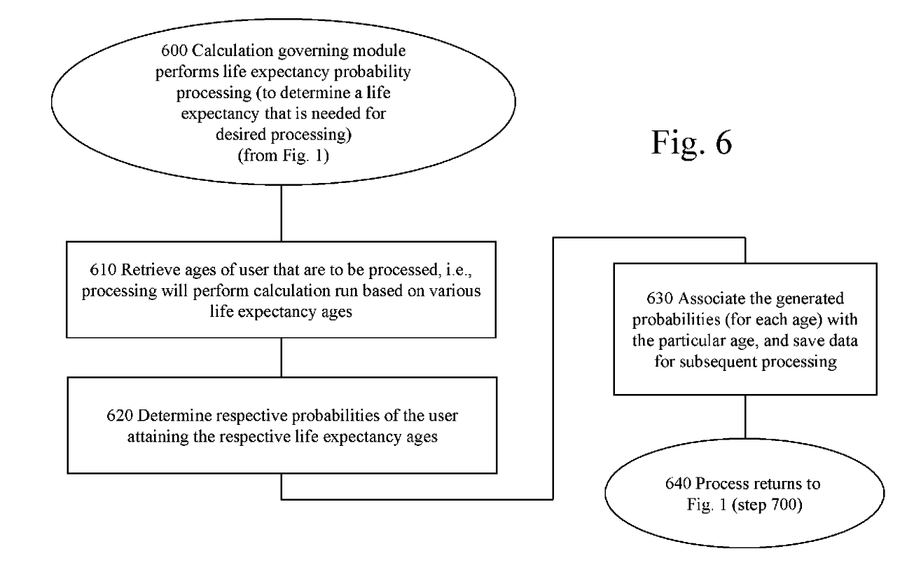

In step 600, the calculation governing module performs life expectancy probability processing. Such processing is performed to determine life expectancy values needed for desired processing. Further details of the processing of step 600 are shown in FIG. 6. Then, the process passes to step 700.

In step 700, the calculation governing module performs the mathematical processing of the particular request from the user. Accordingly, steps 600 and 700 might collectively be characterized as constituting a “calculation run” of the desired processing. Further details are described below.

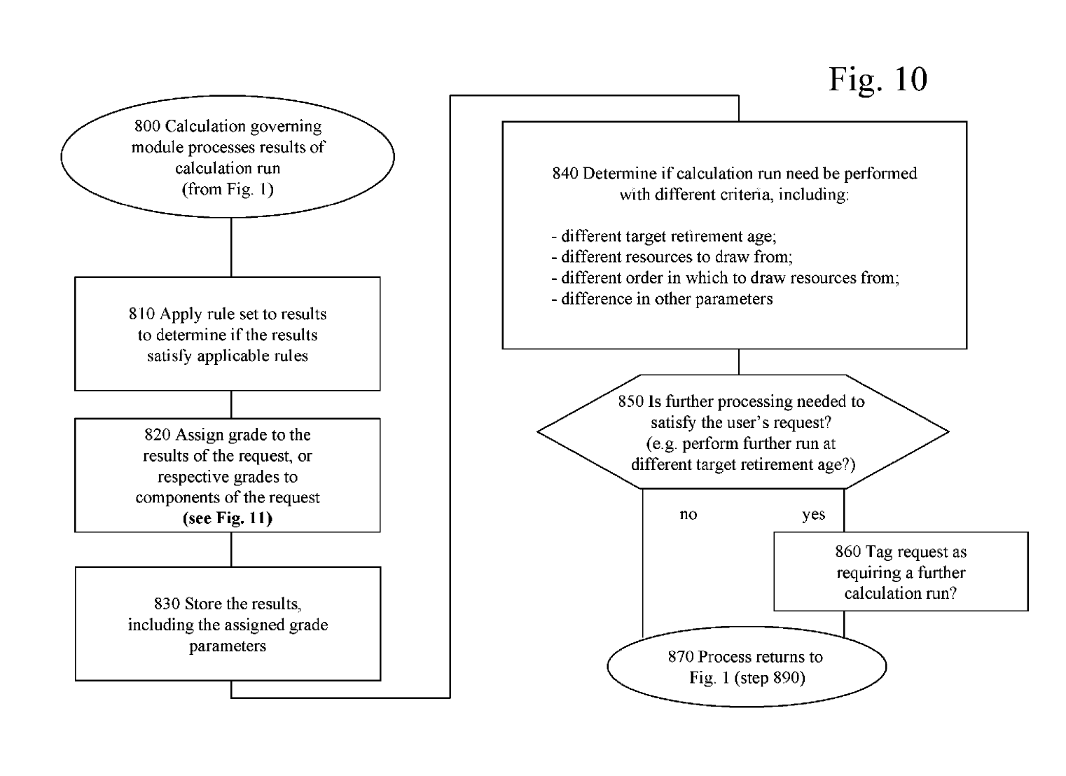

After step 700, the process passes to step 800. In step 800, the calculation governing module processes the results of the calculation run. Further details of the processing of step 800 are shown in FIG. 10.

Then, the process passes to step 890. In step 890, it is determined whether the request from the user is tagged as requiring a further calculation run? That is, in the various processing as described below, it may be the case that the particular request from the user may require multiple calculation runs. Thus, the request may be tagged to reflect such. This tagging may be done as a result of the nature of the request, or based on some results determined in the processing of the request. After step 890, the process passes to step 900.

As reflected in FIG. 1, and described further below in accordance with embodiments of the invention, the processing of steps 600, 700 and 800 may well be performed as one or more runs of data. In other words, the processing of steps 600, 700 and 800 may be performed as a one time run of data in view of a particular scenario, may be performed iteratively in some manner and/or may be performed utilizing a feedback loop or equivalent programming approach. Data may be processed by the financial calculation system 100, for example, in a batch mode and/or in real time as data is made available.

In particular, in the case where a series of runs is performed with different data or different processing, various comparisons may be drawn out from the yielded data, i.e., “yielded data” meaning data generated as a result of the processing of the financial calculation system utilized. In accordance with one embodiment of the invention, such comparisons might be set forth in the form of a matrix or some equivalent representation of the data.

The processing of data may well take into account a plurality of variables and the dependent interrelationship between such variables. Accordingly, for example, processing may utilize time of death parameters, parameters related to medical expenses (e.g. medical claims in a year), as well as the interrelated parameters of asset return and inflation. With desired parameters, multiple runs of data may be performed by the financial calculation system 100 so as to progressively vary parameters in some organized manner. For example, a particular parameter might be gradually incremented while holding other parameters constant, so as to generate a series of results. Thereafter, the previously incremented parameter may be held constant, while incrementing another parameter (e.g. another parameter that was previously held constant). Runs of data, so as to generate comparative results, may number as desired, such as in the 10s, 100s, 1000s or more. The number of runs performed may be dictated by the processing capabilities.

In accordance with one embodiment of the invention, the runs of data may be performed in conjunction with using stochastic related processing, i.e., in that progression of the analysis is based on both predictable actions and random variables. However, other processing approaches may also be utilized.

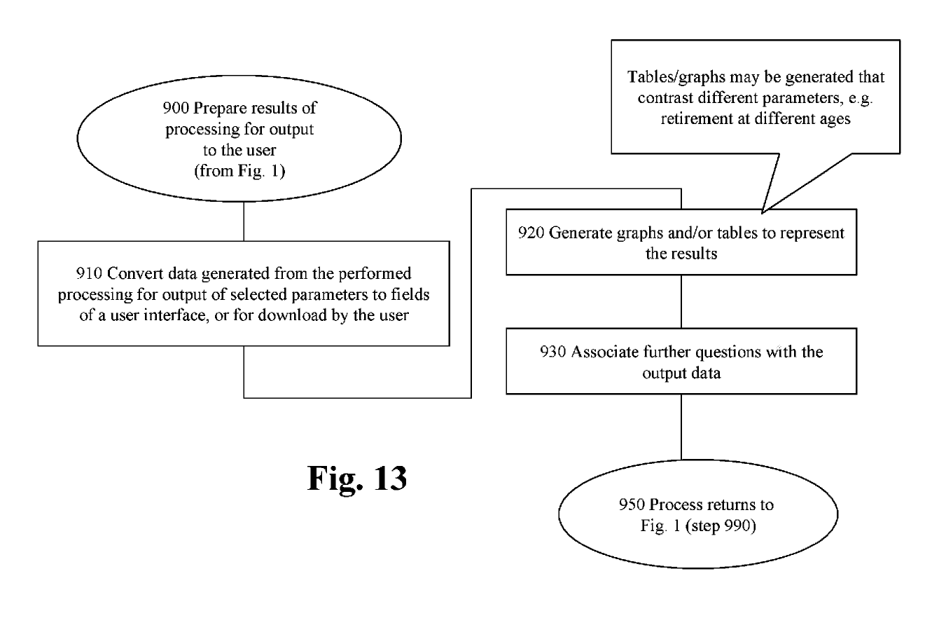

As noted above, after step 890 of FIG. 1, the process passes to step 900. In step 900, the results of the processing are prepared for output to the user. Further details of the processing of step 900 are shown in FIG. 13. Then, the process passes to step 990.

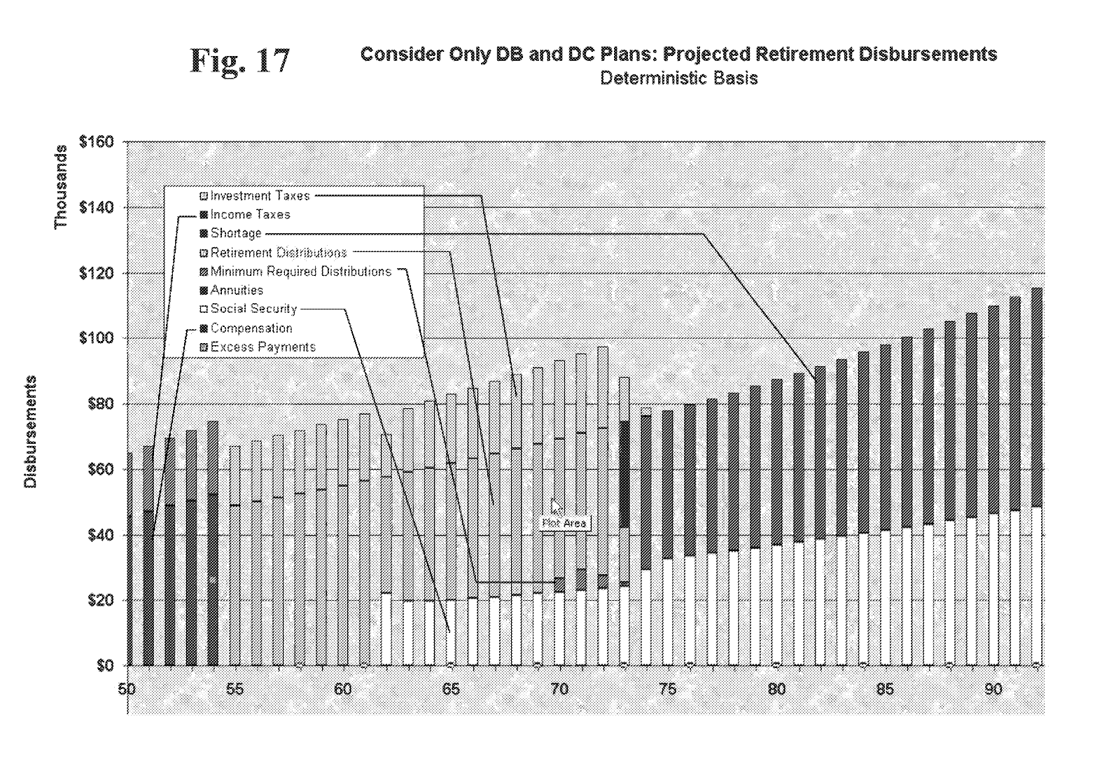

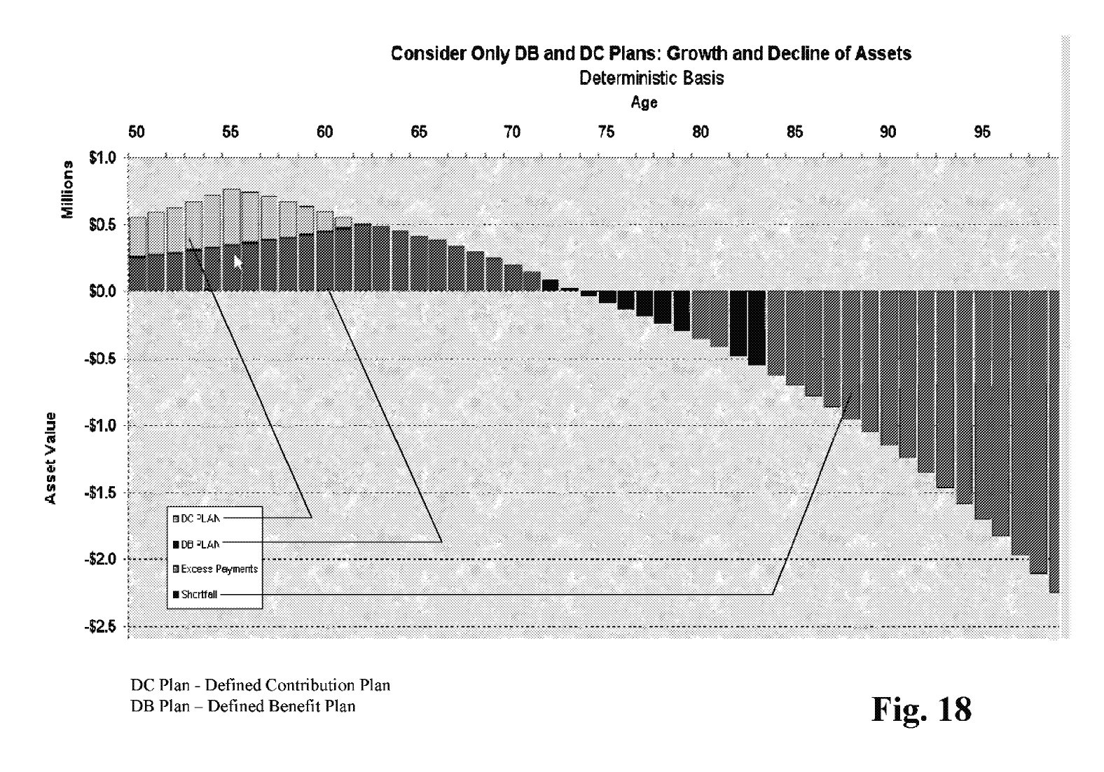

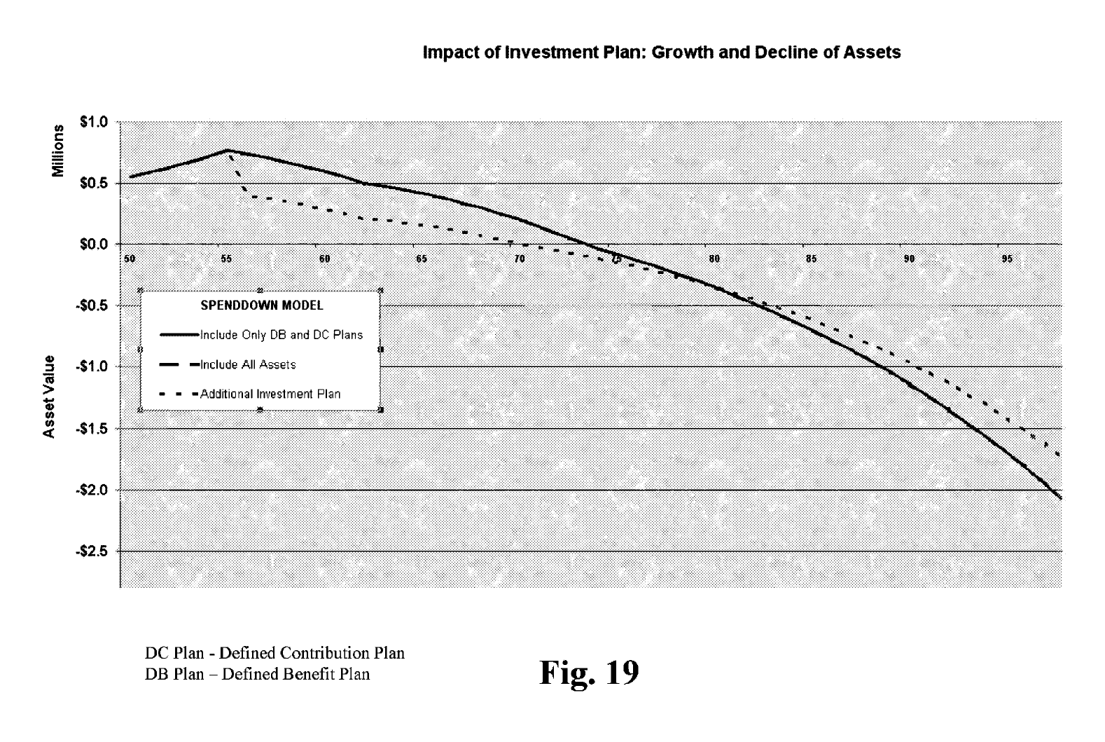

As described herein, it is appreciated that a wide variety of processing may be performed by the financial calculation system 100 and various data generated from such processing. For example, FIG. 17 is a diagram showing the plotting of various retirement disbursements, in accordance with one embodiment of the invention. FIG. 18 is a diagram showing the growth and decline of assets, as the person, i.e., the user, approaches and draws away from the date of retirement, in accordance with one embodiment of the invention. FIG. 19 is a diagram showing the spenddown of assets, in accordance with one embodiment of the invention. It is of course appreciated that the particular number and nature of the assets used in the processing may vary widely.

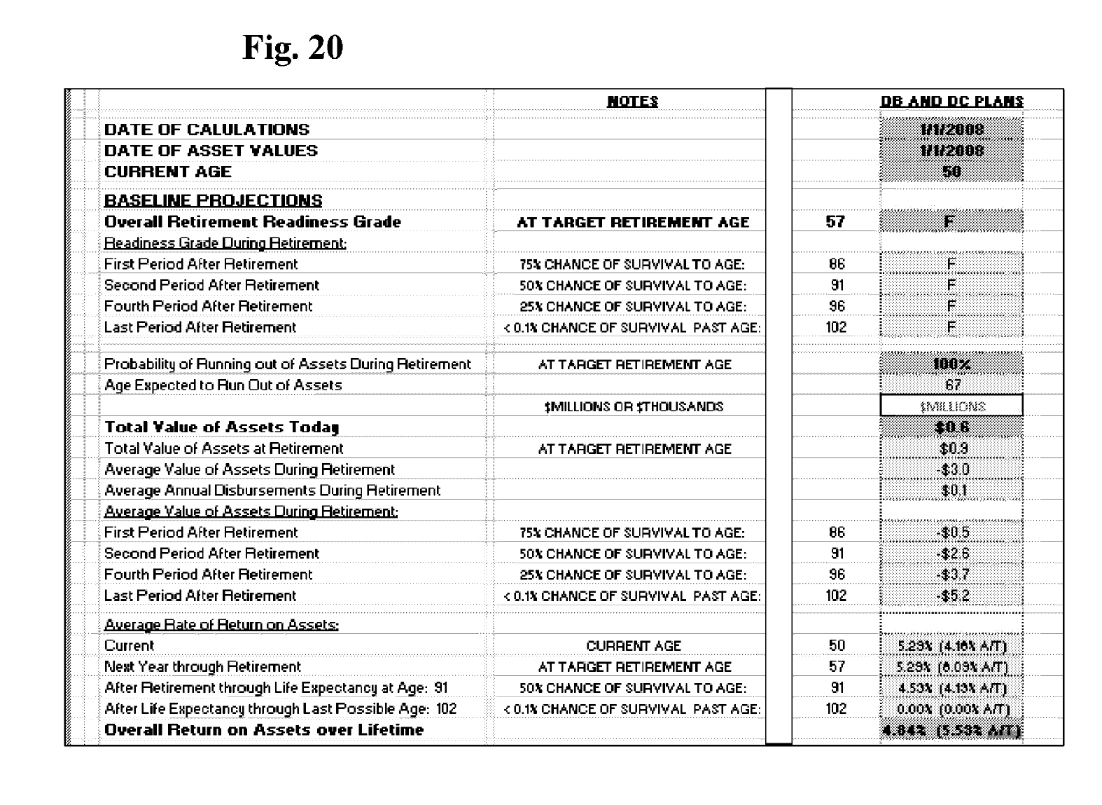

Further, FIG. 20 is a table showing various projections as generated by the financial calculation system, in accordance with one embodiment of the invention. As shown in FIG. 20, and described further below, the projection figures are associated with “grades”. The use of such grades provides the user with a subjective sense of the financial situation. FIG. 20 shows the nature of information that the financial calculation system 100 may use in processing and the parameters upon which the processing may be based. For example, information may be generated based on variance of particular periods after retirement, chances of survival to a particular age, and probability of running out of assets, as well as other parameters.

Returning to the description of FIG. 1, in step 990, the results of the processing are output to the user. Further, step 990 includes storing the results of the processing in some suitable manner. For example, the results of the processing might be stored in a suitable database, and the results being associated with the particular user's profile. Then, the process passes to step 992.

In step 992, a determination is made of whether the user wants to make a further request. For example, the user might want to make a further request using the same calculation, but with different data, or alternatively, the user might want to perform a different calculation. If no, i.e., no further request is received from the user, then the process passes to step 998. In step 998, the processing ends, i.e., the processing for the particular user ends. Further processing may of course be performed for the particular user at some later time.

On the other hand, if yes in step 992, i.e., the user does want to make a further request, then the process passes to step 994. In step 994, the processing returns to step 300, and continues as described above.

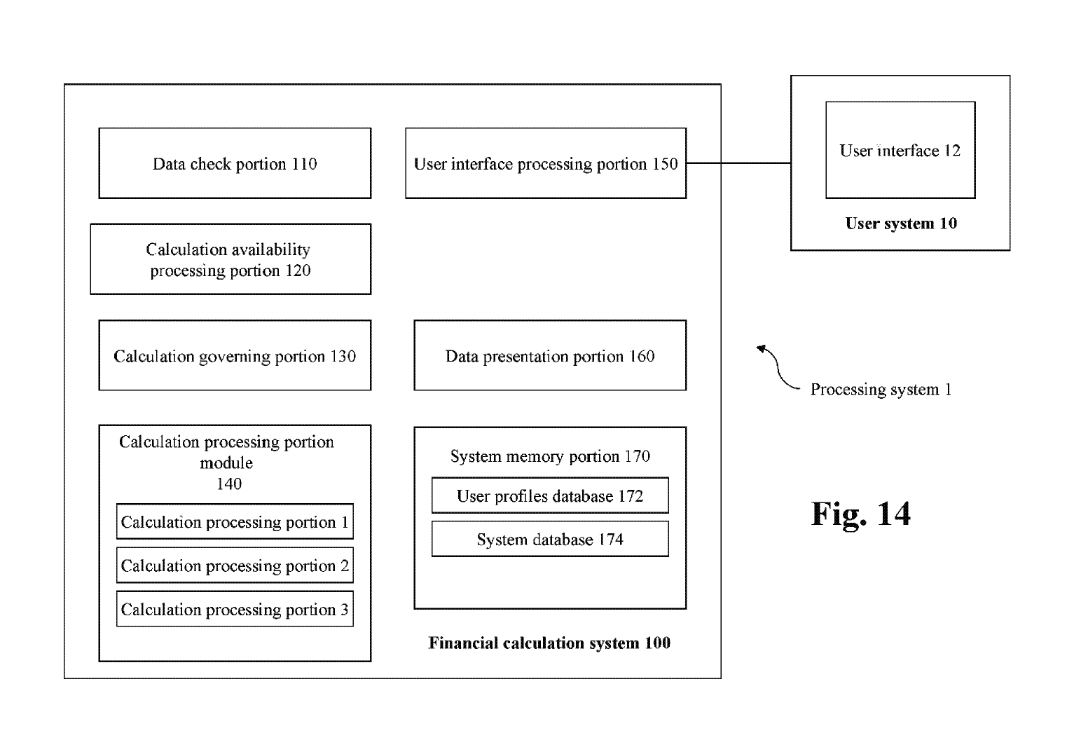

The processing of FIG. 1, and the various other processing as described herein, may be performed by a suitable processing system. In accordance with one embodiment of the invention, FIG. 14 is a block diagram showing a processing system 1, which may be used to practice the methods of the invention.

As shown, the processing system 1 includes a financial calculation system 100 and a user system 10.

The user system 10 may typically be in the form of a personal computer of the user, such as a laptop or special purpose computer. The user system 10 includes a suitable user interface 12, by which the user might interface with the user system 10, and in turn, with the financial calculation system 100. As should be appreciated, there may well be a substantial number of user systems 10 that interface with the financial calculation system 100.

The financial calculation system 100 includes various processing portions described in summary here, and in further detail below. Specifically, the financial calculation system 100 includes a data check portion 110, a calculation availability processing portion 120, a calculation governing portion 130, a calculation processing portion module 140, a user interface processing portion 150, a data presentation portion 160, and a system memory portion 170.

The data check portion 110 performs various data checking, such as to the presence and validity of data. The calculation availability processing portion 120 determines, based on data that is available (e.g. that the user has entered) what calculations are available to the user. The calculation governing portion 130 manages actually effecting the run of calculations, including controlling the serial manner in which calculations are performed, and the transfer of data between respective calculation processing portions. The calculation processing portion module 140 contains the various calculation processing portions that actually perform the needed calculations. The data presentation portion 160 works with information that is generated by the financial calculation system 100, and prepares such information for output to the user.

The user interface processing portion 150 in the financial calculation system 100 controls communications with the various users of the financial calculation system 100.

The financial calculation system 100 further includes the system memory portion 170. The system memory portion 170 contains the various data that is used by, and generated from, the processing of the financial calculation system 100. In particular, the system memory portion 170 includes a user profiles database 172 and a system database 174.

FIG. 2 is a flowchart showing further details of the “perform processing for user, including inputting request and inputting data to process request” of FIG. 1, in accordance with one embodiment of the invention. As shown, this subprocess starts in step 300, and passes to step 310.

In step 310, the processing includes interfacing with the user to present the user with “initial—high level” request options. For example, this processing might include presenting the user with high level options such as “mortgage calculations” or purchase car calculations”, for example. Then, the process passes to step 330.

In step 330, based on particular request option or options that were chosen by the user, the processing portion, and specifically, the user interface processing portion 150 in accordance with one embodiment of the invention, generates a further data entry interface, including input fields for the user to enter in requested data. In accordance with one embodiment of the invention, some fields in such user interface might be pre-populated with known data, i.e., data that has already been secured by the system, either in the current session or in prior sessions.

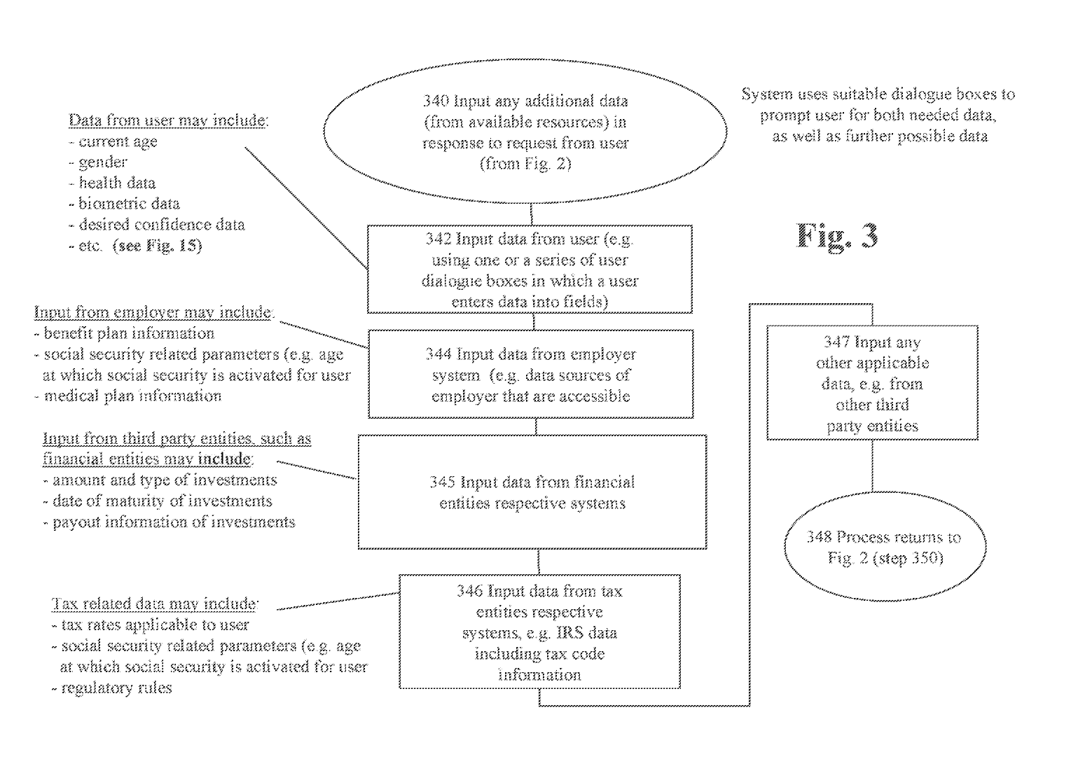

Then, in step 340, the process inputs additional data to respond to the high level request from the user. FIG. 3 shows further details of such processing. In particular, such additional data might be input from the user or from third party entities, for example.

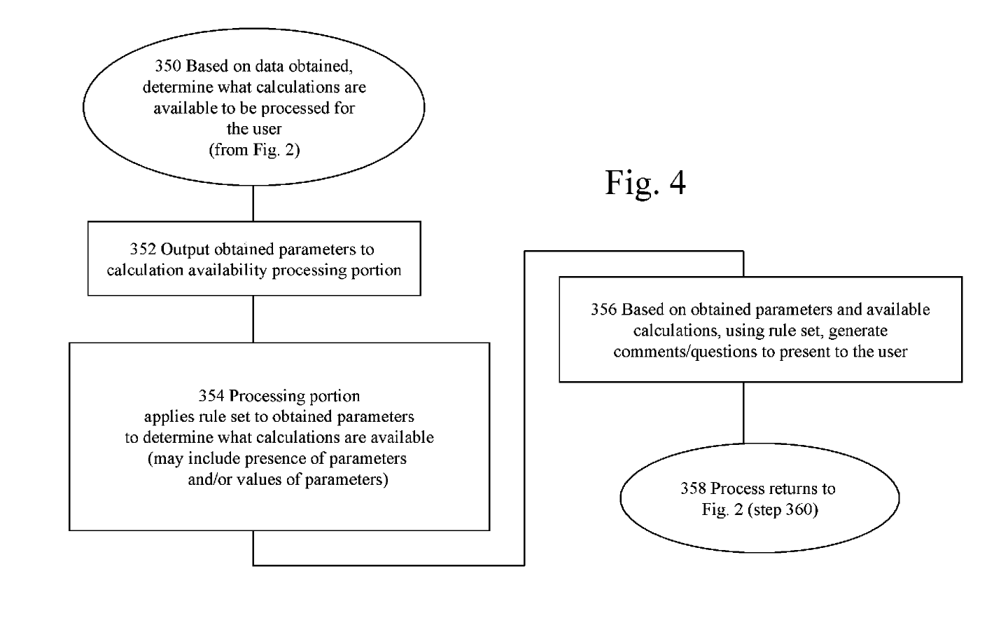

After step 340 of FIG. 2, the process passes to step 350. In step 350, the processing determines what calculations may be performed for the user. That is, step 320 as described above relates to the general area in which the user is interested. Once that area is selected, and data is entered in step 340, then in step 350, the processing assesses what computations, i.e., calculations, might be performed based on what data is available. For example, a calculation relating to stock assets might not be provided, as an option to the user, if the user had provided no stock data. Further details of step 350 are described below with reference to FIG. 4.

After step 350, the process passes to step 360. In step 360, the processing presents the user with the available calculations to choose from, i.e., as such available calculations were determined in step 350. Various other information and questions may be presented to the user. Further, in step 360, the user input is received. Then, the process passes to step 370.

In step 370, the processing determines if input was received from the user to: (A) proceed with processing of a requested calculation based on the obtained information, OR (B) alter the requested calculation in conjunction with securing further data. Thus, option (A) relates to the situation where the user is acceptable to one of the options that is currently provided to the user. On the other hand, option (B) relates to the situation in which the user (perhaps as a result of the information and questions presented to the user) has reconsidered the desired calculation, and, for example, would now like to input further information so as to allow different and/or more detailed calculations.

As shown in FIG. 2, if option (A) is chosen, then the process passes to step 380. In step 380, the process returns to FIG. 1 and step 400. On the other hand, if option (B) is chosen, then the process passes back to step 330. In step 333 then, the processing continues on as described above.

FIG. 3 is a flow chart showing in further detail the “input any additional data (from available resources) in response to request from user” step 340 of FIG. 2, in accordance with one embodiment of the invention. The process of FIG. 3 starts in step 340, and passes to step 342.

In step 342, the processing inputs data from the user, e.g. such as by using one of a series of user dialogue boxes in which a user enters data into fields.

Then, the process passes to step 344. Then, in step 344, the processing inputs data from an employer system of the user, i.e., from data sources of the employer (of the employee) that are accessible by the processing system. Then, the process passes to step 345.

In step 345, the processing inputs data from financial entities respective systems. This processing might include retrieving asset information of the user that is managed by an asset management firm. Such retrieved asset information might include the amount and type of assets held by the user. Then, the process passes to step 346.

In step 346, the processing inputs data from tax entities respective systems, e.g. IRS data including tax code information is input from the IRS web site. Then, the process passes to step 347. In step 347, the processing inputs data from any other applicable data, e.g. from any other third party entities.

In step 348, the processing returns to FIG. 2, and in particular passes to step 350 of FIG. 2.

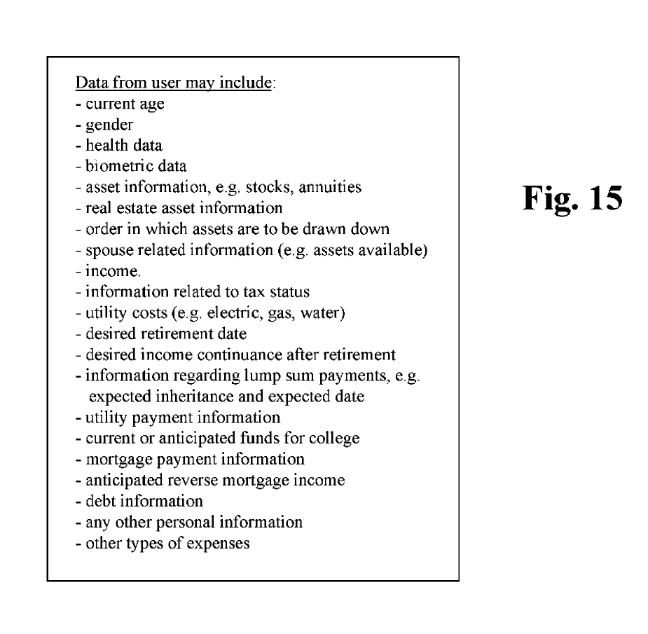

As shown in FIG. 3, associated with each of steps 342-346, is a listing of information that might be secured in the respective processing steps. However, such information is illustrative only and is not limiting. Further, it is appreciated that information shown to be secured in one of the processing steps may well be instead secured in one of the other processing steps. Further, FIG. 15 is a diagram showing further data that might be obtained from the user, in accordance with one embodiment of the invention.

In each of steps 344-347, the process inputs data from a third party entity. Such data might be freely available to the public. On the other hand, such data may be restricted. For example, data in third party systems may require a user name, user password, or other credentials, for example. Such credentials may be provided by the user.

FIG. 4 is a flowchart showing in further detail the “based on data obtained, determine what calculations are available to be processed for the user” step 350 of FIG. 2, in accordance with one embodiment of the invention. As shown, the process starts in step 350, and passes to step 352.

In step 352, the processing outputs all the parameters, i.e., the data/information that has been obtained from the customer, to a calculation availability processing portion, in accordance with one embodiment of the invention. Upon receiving the data, in step 354, the calculation availability processing portion applies a suitable rule set to the obtained parameters to determine what calculations are available. The rule set used may relate to, i.e. be based on, the presence of parameters and/or the values of certain parameters. Then, the process then passes to step 356.

In step 356, based on the obtained parameters and available calculations, the calculation availability processing portion then applies a further rule set, in accordance with one embodiment of the invention, to generate comments and/or questions that will be presented to the user. Thus, for example, if the user provided stock information, the further comments/questions presented to the user might relate to the variance in value of such stocks in recent years.

After step 356, the process passes to step 358. In step 358, the process returns to FIG. 2 and step 360.

FIG. 5 is a flow chart showing in further detail the “data check module performs final check of entered data (e.g. is data complete to allow processing of request)” step 500 of FIG. 1, in accordance with one embodiment of the invention. As shown, the process starts in step 500, and passes to step 510.

In step 510, the processing determines whether all the fields of data are populated so as to be sufficient to process the request from the user. In conjunction with the processing of FIG. 4, in which the available calculations are determined, the processing of FIG. 5 relates more to the nature of the data. That is, it might be the situation that stock assets are provided such that, in the processing of FIG. 4, certain calculations would be deemed available that relate to stock calculations. However, as to the processing of step 510 of FIG. 5, such step would identify, for example, that while certain data was provided, other data is needed. In performing such processing, a suitable set of rules might be utilized. For example, appreciation of an asset might be provided, but the time period over which such appreciation occurred not provided. Thus, step 510 would identify such as a deficiency.

If yes in step 510, then, the process passes to step 520. In step 520, the processing determines whether the values in the populated fields of data are valid. In performing such processing, a suitable set of rules might be utilized. If yes in step 520, then, the process passes to step 530.

In step 530, the process presents an interface to the user, requesting confirmation of the request (which the user has submitted) and validation of the various data being used in request. In step 540, the data that has been entered is saved to the user's profile, or a user's profile is created if not already created.

If any of steps 510, 520 and 530 result in a no determination, i.e., the fields are not correctly populated, the values of the data are not valid, or the data is not acceptable to the user, then the processing g, respectively passes to a halt step, 515, 525 and 535 respectively. In such steps, processing is halted until corrected or further data is obtained from the user, e.g. through suitable interfacing with the user.

After step 540, the process passes to step 550. In step 550, the process returns to FIG. 1, and specifically, passes to step 600 of FIG. 1.

FIG. 6 is a flow chart showing in further detail the “calculation governing module performs life expectancy probability processing (to determine a life expectancy that is needed for desired processing)” step 600 of FIG. 1, in accordance with one embodiment of the invention. As shown, the processing of FIG. 6 starts in step 600, and passes to step 610.

In step 610, the process retrieves the various ages of the user that are to be processed in the particular calculation run being performed. In other words, the processing may perform a calculation run based on a plurality of life expectancy ages. Once the ages are retrieved, the process passes to step 620.

In step 620, the process proceeds to determine the respective probabilities of the user attaining the respective life expectancy ages. This processing may be performed using any of a variety of information, as is known in the art. After step 620, the process passes to step 630.

In step 630, the processing associates the generated probabilities (for each age) with the particular age, and saves the data for subsequent processing.

Then, the process passes to step 640. In step 640, the process returns to FIG. 1, step 700.

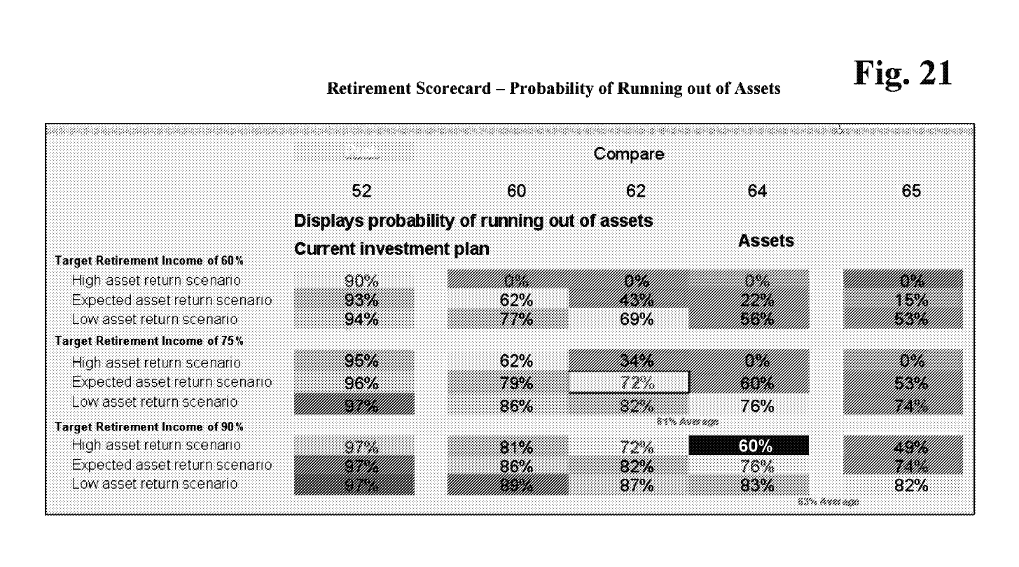

Relatedly, FIG. 21 is a retirement scorecard (showing the probability of running out of assets) generated by the financial calculation system in accordance with one embodiment of the invention. As shown in FIG. 21, the probabilities may be generated based on variance of target retirement income, current age, age of retirement, as well as a variety of other factors, as desired.

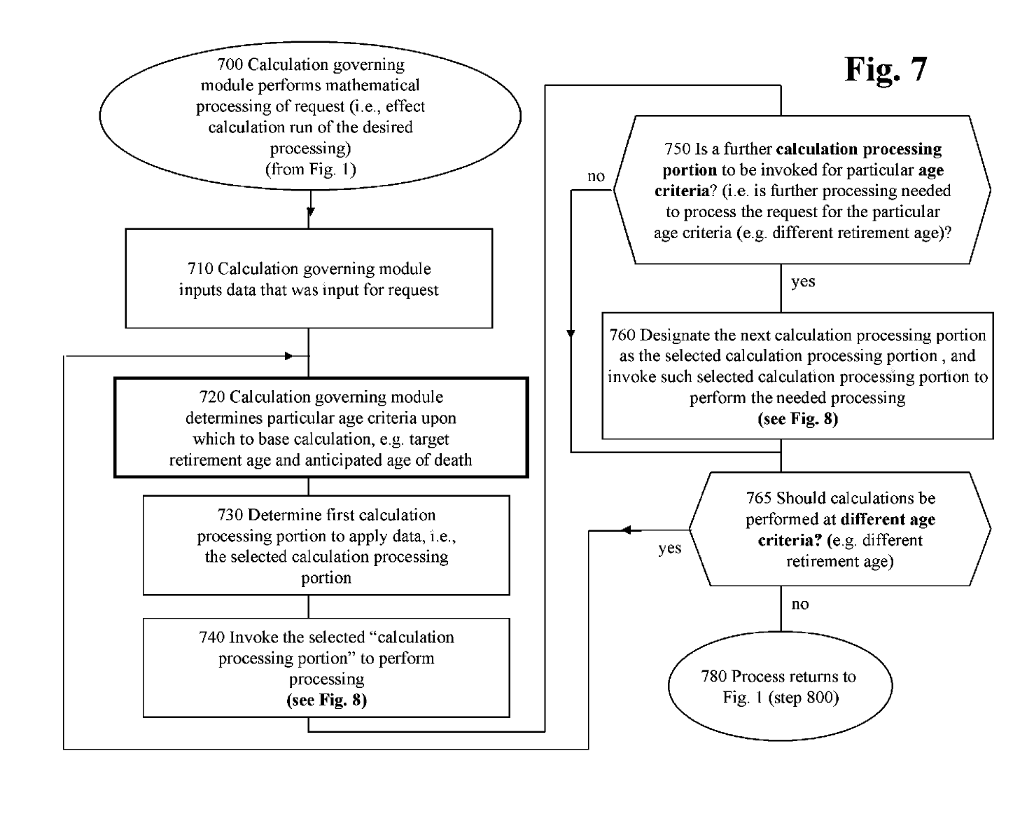

FIG. 7 is a flowchart showing in further detail the “calculation governing module performs mathematical processing of request (i.e., effect calculation run of the desired processing)” step of FIG. 1, in accordance with one embodiment of the invention. As shown, the process starts in step 700, and passes to step 710.

In step 710, the calculation governing module inputs the data that was input for the request. Then, in step 720, the calculation governing module determines the particular age criteria upon which to base the calculation processing to be performed. For example, the age criteria might include the target retirement age and anticipated age of death. Then, the process passes to step 730.

In step 730, the calculation governing module determines a first calculation processing portion to apply the data, i.e., a selected calculation processing portion. To explain, in accordance with one embodiment of the invention, the various processing performed in response to a user request generally includes the use of a plurality of calculation processing portions. One calculation processing portion will process the data first so as to generate resultant data, i.e., data yielded as a result of the processing of the first calculation processing portion. Then, such resultant or yielded data will be output back to the calculation governing module, at which time the calculation governing module will determine the next calculation processing portion to process the data. Once the next calculation processing portion is determined, the needed data to perform such calculation by the next calculation processing portion is output. Such data may include the resultant or yielded data from past processing, as well as the data obtained from the user or third party, i.e., “raw data”. The processing of FIGS. 7-9 are reflective of this progression.

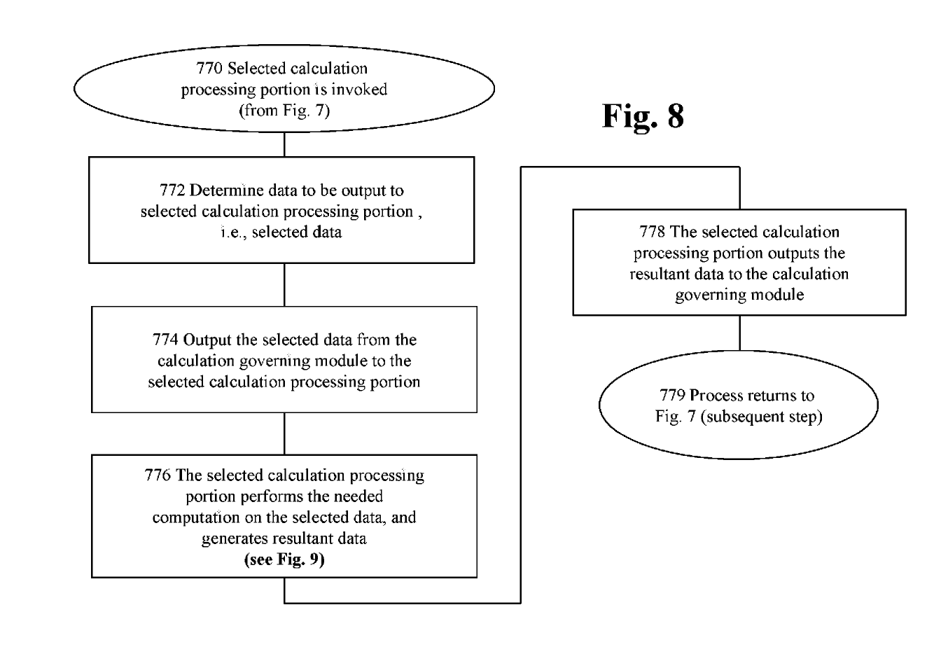

That is, as shown in FIG. 7, after the first calculation processing portion is determined in step 730, the process passes to step 740. In step 740, the calculation governing module invokes the particular calculation processing portion to perform the needed processing. Further details are shown in FIG. 8.

After step 740, the process passes to step 750. In step 750, the process determines if a further calculation processing portion to be invoked for particular the particular age criteria being processed, i.e. is further processing needed to process the request for different age criteria, and in particular a different retirement age, for example. Note that such further processing would likely use the yielded data from the prior processing, but not necessarily, i.e., computations might be performed in parallel.

If yes in step 750, i.e., further processing is needed, then the process passes to step 760. In step 760, the processing determines what calculation processing portion is the next calculation processing portion, i.e., the selected calculation processing portion, and invokes such selected calculation processing portion to perform the needed processing. Further details are shown in FIG. 8.

After step 760, the process passes to step 750.

As described above, in step 750, the process determines if a further calculation processing portion is to be invoked for the particular age criteria being processed. If no in the decisioning of step 750, i.e., a further calculation processing portion should not be invoked for the particular age criteria, then the process also passes to step 765.

In step 765, the calculation governing module 130, in accordance with one embodiment of the invention, determines that further calculations should be performed at different age criteria, e.g. for a different retirement age. That is, in the processing of FIG. 7, it may be the situation that a series of loops of the processing are performed, each with different age criteria. For each age criteria, the same calculations would be performed, and thus the same calculation processing portions would be invoked. Such multiple processing with different age criteria would generate a series of data that would then be used in later processing.

If yes in step 765, i.e., further processing should be performed with different age criteria, then the process passes to step 720. In step 720, the calculation governing module determines, i.e., or retrieves from memory, further age criteria upon which to run the calculations. Processing then proceeds as described above.

On the other hand, if no in step 765, i.e., further processing should not be performed with different age criteria, then the process passes to step 780. In step 780, the returns to FIG. 1, and specifically step 800 of FIG. 1.

FIG. 8 is a flowchart showing in further detail the “selected calculation processing portion is invoked” processing of FIG. 7, in accordance with one embodiment of the invention. As shown, the process starts in step 770 of FIG. 8, and passes to step 772.

In step 772, the calculation governing module 130 determines which data to be output to the selected calculation processing portion, i.e., determines the selected data. Then, in step 774, the calculation governing module outputs the selected data from the calculation governing module to the selected calculation processing portion. Then, the process passes to step 776.

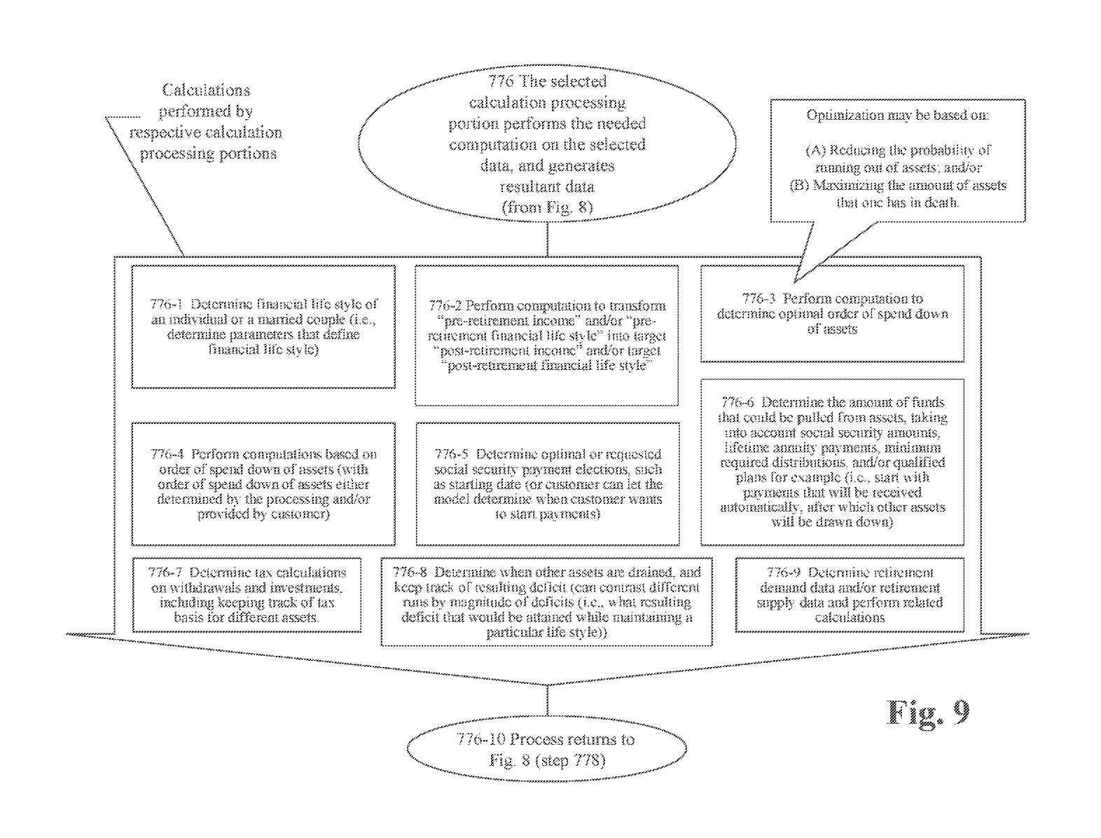

In step 776, the selected calculation processing portion performs the needed computation on the selected data, and generates resultant data, i.e., the yielded data. Further details of step 776 are shown in FIG. 9.

After step 776 of FIG. 8, the process passes to step 778. In step 778, the selected calculation processing portion outputs the resultant data to the calculation governing module. Then, the process passes to step 779. In step 779, the process returns to FIG. 7, and in particular the step of FIG. 7 subsequent to the step of Fig. from which the flow to FIG. 8 originated.

FIG. 9 is a flowchart showing in further detail the “selected calculation processing portion performs the needed computation on the selected data, and generates resultant data” step of FIG. 8, in accordance with one embodiment of the invention. FIG. 9 reflects that a wide variety of calculations, and processing portions to perform those calculations, may be implemented in conjunction with responding to a request from a user, so as to yield data to satisfy the user's request. As controlled by the calculation governing module, in accordance with one embodiment of the invention, respective calculation processing portions are invoked so as to perform the desired processing.

As illustratively shown in step 776-1, one calculation processing portion may determine financial life style of an individual or a married couple (i.e., determine parameters that define financial life style). As reflected in step 776-2, another calculation processing portion may perform computation to transform “pre-retirement income” and/or “pre-retirement financial life style” into target “post-retirement income” and/or target “post-retirement financial life style.” As reflected in step 776-3, a calculation processing portion may perform computation to determine optimal order of spend down of assets. The optimal order of spenddown of assets may depend on a variety of parameters, as desired. For example, in accordance with one embodiment of the invention, optimization may be based on: (A) reducing the probability of running out of assets; and/or (B) maximizing the amount of assets that one has in death.

As shown in FIG. 9, steps 776-4 to 776-8 show further processing that may be performed by respective calculation processing portions, e.g. that are in the calculation processing portion module 140. As reflected in step 776-4, a calculation processing portion may perform computations based on order of spend down of assets (with order of spend down of assets either determined by the processing and/or provided by customer). As reflected in step 776-5, a calculation processing portion may determine optimal or requested social security payment elections, such as starting date (or customer can let the model determine when customer wants to start payments). As reflected in step 776-6, a calculation processing portion may determine the amount of funds that could be pulled from assets, taking into account social security amounts, lifetime annuity payments, minimum required distributions, and/or qualified plans for example (i.e., start with payments that will be received automatically, after which other assets will be drawn down). As reflected in step 776-7, a calculation processing portion may determine tax calculations on withdrawals and investments, including keeping track of tax basis for different assets. As reflected in step 776-8, a calculation processing portion may determine when other assets are drained, and keep track of resulting deficit (can contrast different runs by magnitude of deficits (i.e., what resulting deficit that would be attained while maintaining a particular life style)). In step 776-9, the calculation processing portion may determine retirement demand data and/or retirement supply data and perform related calculations. The various calculation processing portions shown in FIG. 9 may be invoked by the calculation governing module 130 either serially or in parallel. Data that is generated from the processing of one calculation processing portion may well be then used as input into a subsequent calculation processing portion.

As shown in FIG. 9, after the calculation governing module invokes the needed calculation processing portions, the processing passes to step 776-10. In step 776-10, the process returns to FIG. 8 (step 778).

FIG. 10 is a flowchart showing further details of the “calculation governing module processes results of the calculation run” step of FIG. 1, in accordance with one embodiment of the invention. As shown, the process starts in step 800 and passes to step 810.

In step 810, the processing applies a suitable rule set to the results to determine if the results satisfy applicable rules. Such rules may vary widely depending on the particular processing performed, such as determining if the values of the parameters are acceptable, assessing relationships between the parameters, and outputting certain messages or prompts to the user, as triggered by the rules.

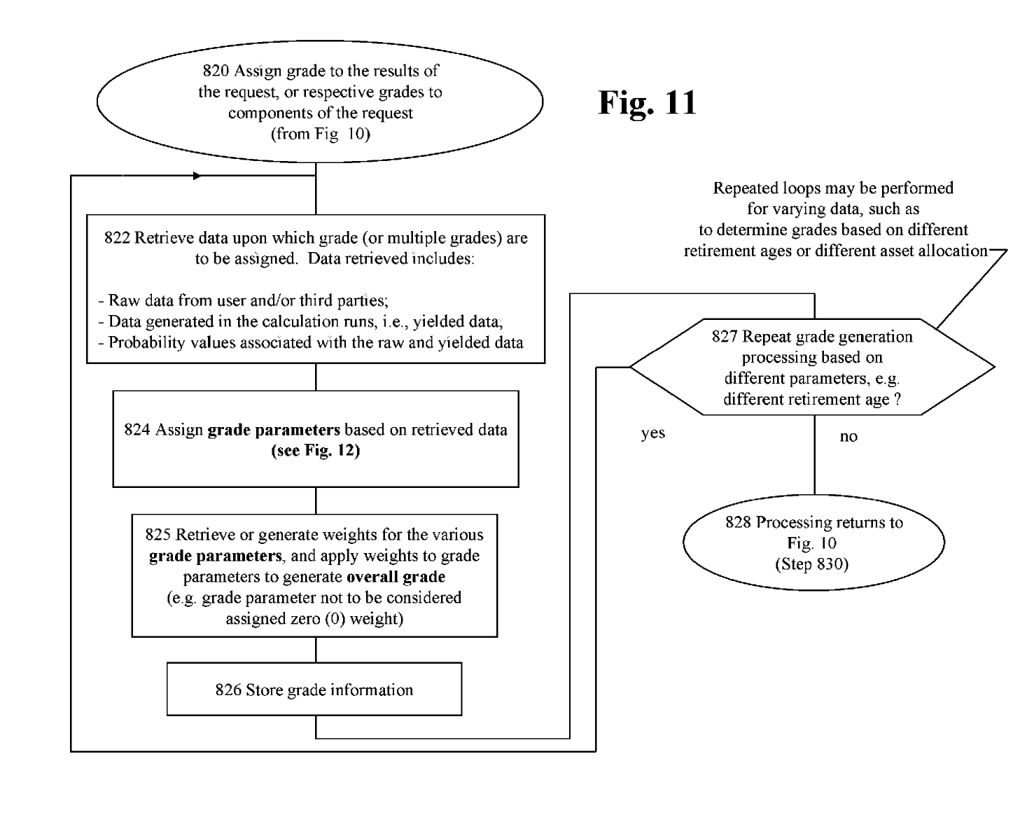

After step 810, the process passes to step 820. In step 820, the processing assigns a grade to the results of the request, or respective grades to components of the request. Further details of such processing are described below with reference to FIG. 11.

Then, in step 830, the results are stored, including the assigned grade parameters. Then, the process passes to step 840. In step 840, the processing determines if a further calculation run need be performed with different criteria, including, for example:
different target retirement age;
different resources to draw from;
different order in which to draw resources from; and/or
difference in other parameters.

After step 840, the process passes to step 850, if further processing is needed (as a result of the determination in step 840), then the process passes to step 860. In step 860, the particular request of the user is associated with a tag that reflects that the request requires a further calculation run. Subsequent processing is then performed as described below.

Then, the process passes to step 870. In step 870, the process returns to FIG. 1 (step 890).

On the other hand, if no in step 850, i.e., no further processing is needed, then the process passes directly to step 870, and thereafter returns to FIG. 1, as noted above.

FIG. 11 is a flowchart showing further details of the “assign grade to the results of the request, or respective grades to components of the request” step 820 of FIG. 10, in accordance with one embodiment of the invention.

As shown, the process starts in step 820, and passes to step 822.

In step 822, the processing retrieves data upon which a grade (or multiple grades) are to be assigned. In accordance with one embodiment of the invention, data retrieved and used in the generation of grades may include: (1) raw data from user and/or third parties; (2) data generated in the calculation runs, i.e., yielded data; and (3) probability values associated with the raw and yielded data.

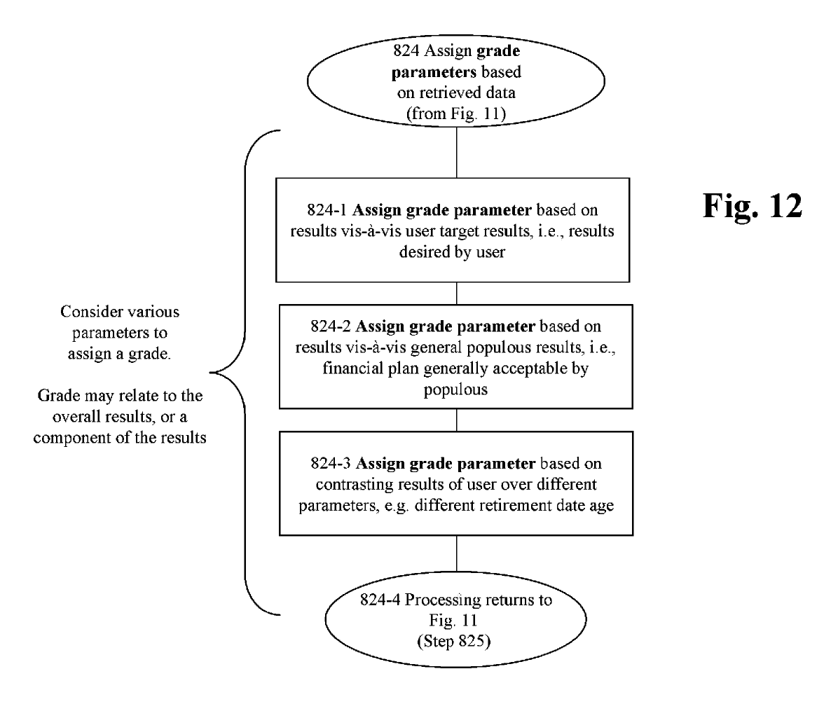

After step 822, the process passes to step 824. In step 824, the processing assigns grade parameters based on the retrieved data. As described below, FIG. 12 shows further details of the assignment of such grade parameters. As a result of the processing of step 824, various parameters associated with the users request are assigned what is herein characterized as a “grade.” For example, the grade might relate to how well the user is set up for retirement at age 62. Such grade may be based on a variety of parameters (as described in step 824) such as results of the calculation run vis-à-vis the desired target results of the user, or results of the calculation run vis-à-vis values generally accepted by the populous.

Thus, for example, if the processing as described herein might yields a result of the user having 2.5 million in savings at age 75, assuming retirement at age 62. Contrasting such savings with a user target savings at age 75 of 2.0 million might well result in a very good grade, e.g. an “A”. However, if the general accepted populous savings at age 75 is 3.0 million, such would result in a poorer grade, such as a “C”.

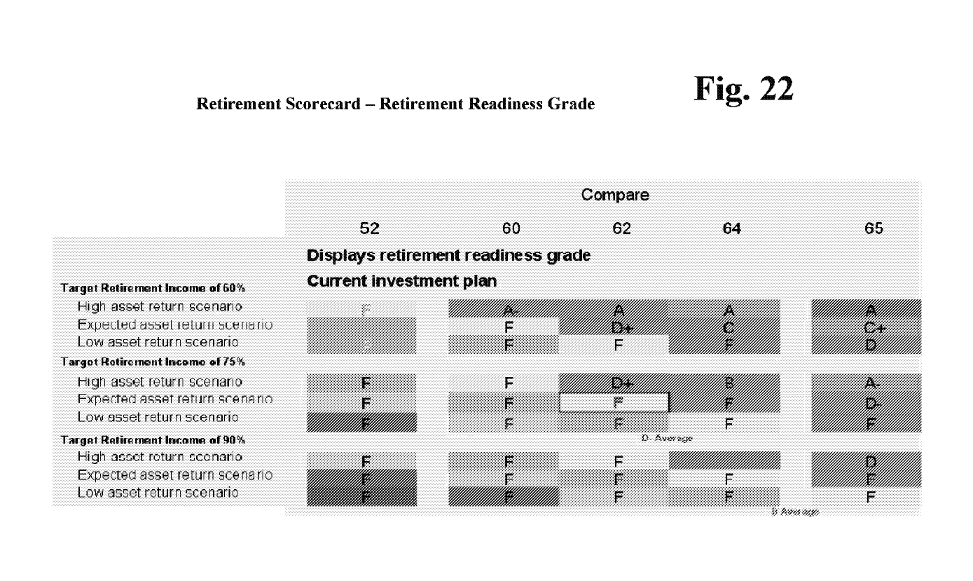

FIG. 22 is a retirement scorecard (showing grades for retirement readiness) generated by the financial calculation system, in accordance with one embodiment of the invention. As shown in FIG. 22, the grades may be generated based on variance of target retirement income, current age, age of retirement, as well as a variety of other factors, as desired.

Accordingly, in step 825 of FIG. 11, (which is performed after step 824) the processing weights the various grade parameters that were assigned in step 824, so as to determine an overall grade. Thus, for example, if the user has conveyed that they wish the grade to be exclusively based on their own target values, then such grade parameter might be given a weight of “1”, whereas all the other grade parameters are assigned a value of “0”. It is of course appreciated that such weighting may be done in any of a wide variety of manners, i.e., such that the relative importance of the assigned grade parameters is taken into account.

After step 825 of FIG. 11, the process passes to step 826. In step 826, the processing stores the various grade information that has been generated. Then, the process passes to step 827.

In step 827, decisioning is performed as to whether the grade generation processing should be repeated based on different parameters, e.g. different retirement age. If yes, then the process passes to step 822. Processing then proceeds as described above.

Alternatively, if processing should not be repeated based on different parameters, i.e., no in step 827, then the process passes to step 828.

In step 828, the processing returns to FIG. 10, and specifically, the processing passes to step 830 of FIG. 10.

In accordance with one embodiment of the invention, FIG. 12 is a flowchart showing in further detail the “assign grade parameters based on retrieved data” step of FIG. 11. As shown, the process starts in step 824, and passes to step 824-1.

In step 824-1, the processing assigns a grade parameter based on results, e.g. yielded data from performing a calculation run, vis-à-vis user target results, i.e., results desired by user.

Then, in step 824-2, the processing assigns a grade parameter based on results vis-à-vis general populous results, i.e., vis-à-vis values of a financial plan generally acceptable by populous. After step 824-2, the process passes to step 824-3.

In step 824-3, the process assigns a grade parameter based on contrasting results of the user over different parameters, e.g. over different retirement date ages. The processing of step 824-3 might be equated to “grading a curve,” such that the respective grades convey a sense of the relative benefits of retiring at different ages.

After step 824-3, the process passes to step 824-4. In step 824-4, the processing returns to FIG. 11 (Step 825).

FIG. 13 is a flowchart showing further details of the “prepare results of processing for output to the user” step 900 of FIG. 1, in accordance with one embodiment of the invention. As shown, the process of FIG. 13 starts in step 900, and passes to step 910.

In step 910, the data presentation portion converts data, that has been generated from the performed processing, for output of selected parameters to fields of a user interface, for example. The data presentation portion may also prepare the data for download to the user. Then, the process passes to step 920.

In step 920, the data presentation portion generates graphs and/or tables to represent the results. In general, tables and/or graphs may be generated that contrast different parameters, e.g. retirement at different ages. Then, in step 930, the data presentation portion associates various questions and/or comments to the results of the processing, such as for example to explain the nature of the results.

In general, FIG. 13 reflects that the data that is generated may include a wide range of information in a wide range of formats. Such data that is presented to the user may well include both yielded data, i.e., data that the processing generated, as well as raw data, such as data that was provided from the user or from third party.

After step 930 of FIG. 13, the process passes to step 950. In step 950, the process returns to step 990 of FIG. 1.

In accordance with a further embodiment of the invention, the financial calculation system 100 may be used to determine probabilistic outcomes of retirement demand (longevity) and retirement supply (retirement resources), and based on a chosen chance of success determine the intersection of retirement supply and demand, i.e., determine and “optimal retirement age”.

Retirement demand may be represented by the number of years of income protection needed in retirement based on individual longevity expectations, for example. Such calculations may be performed by the calculation processing portion module 140, discussed above and shown in FIG. 9. The user may input a desired confidence level, i.e., a “likelihood of success” to use in the calculations. Such may be input in the processing of FIG. 3 described above.

Relatedly, retirement supply may be represented by the number of years that an individual's resources are expected to last in retirement based on chosen spend-down assumptions and desired income level, for example. Such calculations may be performed by the calculation processing portion module 140, the calculation processing portion module 140 being discussed above and shown in FIG. 9. The user may input the desired confidence level to use in the calculations, as described herein. The retirement supply and demand data may then be presented to the user in some suitable form, such as in step 920 of FIG. 13 described above.

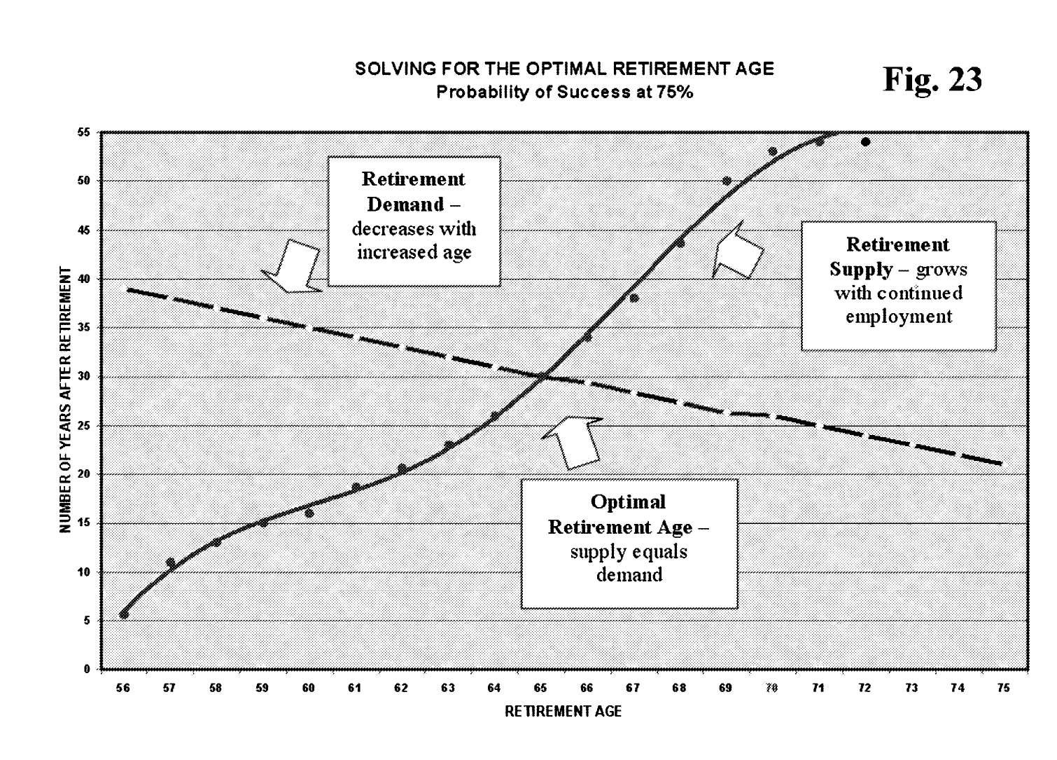

FIG. 23 is a diagram showing the results of such retirement demand (longevity) and retirement supply (retirement resources) processing, in accordance with one embodiment of the invention. The calculation processing portion module 140 may be used to determine an “optimal retirement age” for a user using some or all of a retirement plan sponsor's active employee data, for example, as well as other data. In FIG. 23, the vertical-axis denotes the number of years after retirement. The horizontal axis denotes the retirement age. FIG. 23 plots retirement demand against retirement supply. As shown in FIG. 23, retirement demand decreases with increased age, i.e., since as a person gets older there are fewer anticipated years in which they are expected to live. On the other hand, retirement supply grows with continued employment, i.e., as a person continues to work the retirement funds secured from that work continue to grow. Other assets may also continue to grow. As shown, at a particular point, the retirement demand and the retirement supply curves intersect. It is this point that may be characterized as an optimal retirement age.

In accordance with one aspect of the invention, the “optimal retirement age” output data can be calculated before and after certain “events” in order to measure the impact of changes in the environment (for example, before and after the “market meltdown” in 2008, or before and after a significant change in plan design). Additional data may well be needed to isolate the particular event, i.e. such as 401(k) balance data before and after market downturn in 2008, or projected pension plan benefit information before and after some event. Such additional input data may be input in accord with FIG. 3 described above.

In accordance with one aspect of the invention, a plan sponsor, financial consultant, and/or some other person (or a computer system in some automated manner) may determine an appropriate set of assumptions to use for projection processing (i.e. mortality assumption, assumptions about sources of retirement income inside and outside of plan sponsor plans, salary increase assumptions, and market return assumptions, for example.). Such additional input data may be input in accord with FIG. 3 described above.

The “optimal retirement age” output data and impact of events may be compiled into report(s) for analysis, such as in step 920 of FIG. 13. Any and all of the output data can also be extracted for use in participant benefit statements, including but not limited to projected retirement supply values, projected retirement demand values, optimal retirement age, projected retirement income at various ages, expected longevity at various ages, and probability of retirement supply being sufficient to meet retirement demand, for example. Input data, assumptions and output data will be stored for future use and reprocessing.

Hereinafter, further aspects of the financial calculation system 100 will be described.

The financial calculation system 100 as described herein provides for analysis of individual retirement planning and provides analytical tools to assess retirement readiness in a very non-traditional way. The financial calculation system 100 also provides for various other analysis, planning, and/or forecasting. For example, the financial calculation system 100 can help plan sponsors and HR (human resource) professionals manage their complex retirement program strategy by providing cues for the design, funding and administration of their plans.

Instead of trying to answer the traditional question, “Will I have enough money to retire when I want to,” the financial calculation system 100 allows one to answer the question “At what age will I have enough money to retire?” The reality is that retirement age is the retirement planning variable that:
individuals exercise the most control over,
is likely to have the most financial impact on a retirement plan and
plan sponsors have the most interest in monitoring and helping to manage.

Studies have shown that participants do not make changes to other key retirement planning variables (savings rate, investment mix, as examples) even in the face of extreme market conditions.

In utilization of the financial calculation system 100, both longevity and wealth can be understood in terms of the length of the post-retirement period: the number of years, post-retirement, that an individual's life will last and that his or her wealth will last. These variables may be thought of in terms of demand and supply. Longevity (how long one actually lives) “defines” demand; wealth (retirement resources broadly defined) “defines” supply. Setting aside any legacy objective (i.e., assets to pass on to one's survivors), a goal is to make post-retirement wealth last over the individual's post-retirement life. That is, to make sure demand and supply are in equilibrium.

It is appreciated that one may underestimate the effect the timing of retirement has on the balance between supply and demand. Accelerating retirement age generally results in (1) a longer post-retirement period and thus greater demand and (2) a reduction in the supply of wealth—after earlier retirement the individual is no longer earning wages that can be saved. Conversely, deferring retirement age generally results in (1) a shorter post-retirement period and thus a decrease in demand and (2) an increase in the supply of wealth, funded out of the wages the individual continues to earn. Thus, decisions about retirement age affect both sides of the equation.

The financial calculation system 100 provides a very intuitive way of looking at retirement planning. As described above, the graph of FIG. 23 illustrates the retirement supply and demand model assuming a 75% probability of retirement success, taking into account both the market risk and longevity risk that the hypothetical retiree faces. In the example of FIG. 23, an employee might be covered under a retirement program that includes a traditional pension plan and matching 401(k) plan.

It is appreciated that there are various ways to look at the optimal retirement age solution. In particular, there are various assumptions to be made and levers that a plan sponsor can utilize to impact the supply side of the optimal retirement age solution, such including the:
relative mix of and level of retirement income—Social Security, pension and 401(k)
availability of Roth vs. Traditional 401(k)
availability of a pension annuity (or lump sum)
amount of employer 401(k) contributions and the influence on participant saving patterns
existence of automatic savings and investment features and defaults
   All of these levers have an influence on the optimal retirement age and a financial planner, using the financial calculation system 100, can gain insight into the relative power of any given change by measuring the change in terms of increasing or decreasing the optimal retirement age.

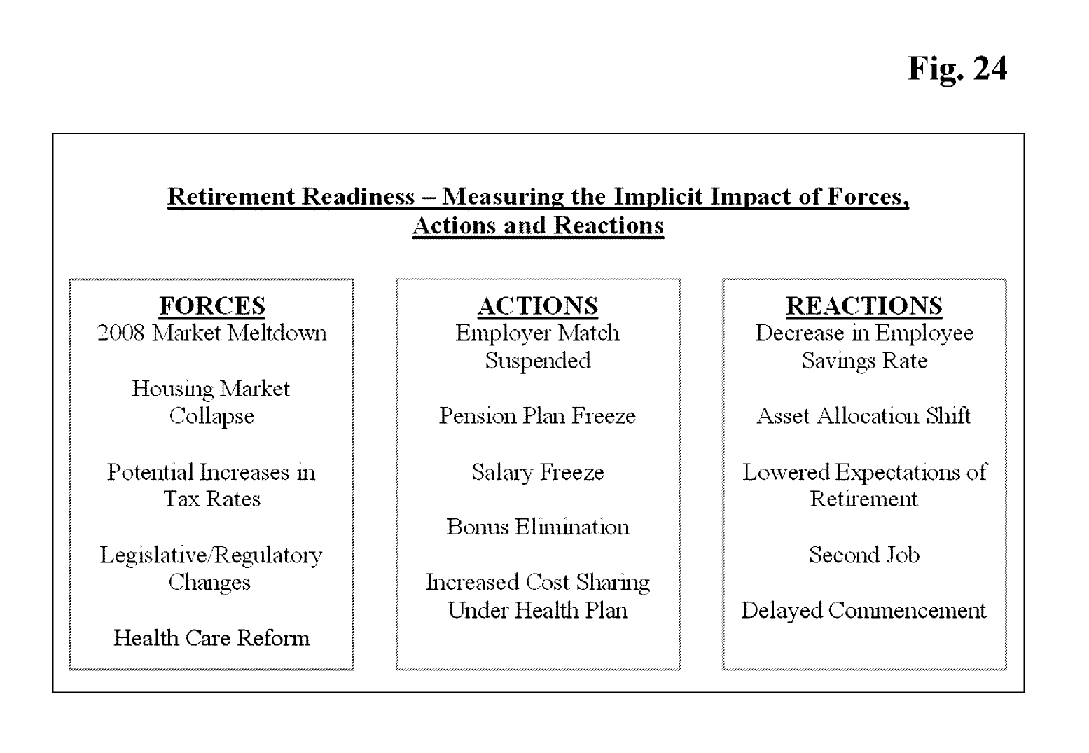

Using the optimal retirement age model provided by the financial calculation system 100, it is possible to get a clearer picture of how well employees are preparing for a successful retirement and the role of a sponsor's retirement program in that success. In addition, it is possible to measure the relative impact of the outside FORCES (changes not in your control), ACTIONS (changes in your control, like plan design changes or salary freezes) and REACTIONS (employee changes due to FORCES and ACTIONS) that are constantly increasing or decreasing the optimal retirement age. Various other parameters may also be considered. FIG. 24 is a table showing aspects of retirement readiness relating to measuring the implicit forces, actions and reactions that may be in play, in accordance with one embodiment of the invention.

The parameters of FIG. 24 collectively, in conjunction with utilization of the financial calculation system 100, provides a framework to explore many of the following illustrative questions and ultimately guide retirement program strategy:
How long should employees expect to delay retirement due to the 2008 market meltdown?
What would the impact on retirement age be if employer 401(k) contributions were suspended for one year?
What would the impact on retirement age be if the pension plan were frozen?
What if tax rates increase significantly?
What if interest rates increase?
What if annuity features are added to the retirement program?
Will employee behavior begin to change, especially if program features are changed?
What is the cumulative impact of all of these changes?

Armed with the answers to these questions (and further questions that may arise from a detailed analysis), a planner can assess the overall success of their retirement program and the implications on optimal retirement age (and thus, workforce management) on any design or compensation decisions that are being considered.

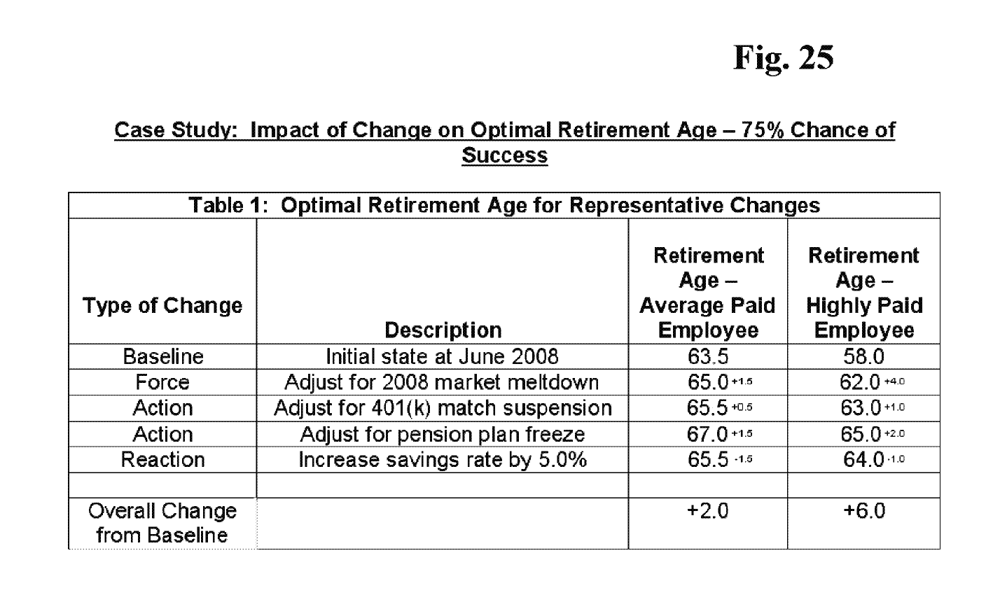

FIG. 25 is a table showing a case study in accordance with one embodiment of the invention. The case study provides a more detailed look at the implicit impact framework and specific results for a large plan sponsor.

Using data from a fairly typical plan sponsor with a cash balance pension plan and a matching 401(k) plan, FIG. 25 shows an analysis of the optimal retirement age for two 50-year old employees—one with “average pay” (in this case, $75,000 per year) and one with “high” pay (in this case, $150,000 per year).

The results reveal that the market meltdown in 2008 had a significant impact on the optimal retirement age for the highly paid employee—a 4-year increase. In fact, the market change had a larger impact than the combined effects of suspending the 401(k) match for one year and freezing the pension plan.

The results also show that Social Security and pension benefits have a relatively larger influence on retirement readiness for the average employee. For the average employee, freezing the pension plan had a larger impact on optimal retirement age than the market meltdown.

For both employees, the financial calculation system 100 was also used to model a 5% increase in retirement savings to gauge the ability of the employee to counteract the other forces/actions in play. As one can see, increasing savings by 5% (a significant increase for many) would only improve optimal retirement age by 1.0 to 1.5 years.

The results shown are representative but will vary significantly depending on the mix of pension vs. 401(k) assets, the participant's investment mix, the assumed probability of retirement success, and the features of the retirement program—particularly the availability of pension early retirement subsidies and lump sum distribution options.

Hereinafter further aspects of the invention relating to retirement supply and demand will be described.

Both longevity and wealth can be understood in terms of the length of the post-retirement period: the number of years, post-retirement, that an individual's life will last and that his or her wealth will last, for example. These variables may be thought of in terms of demand and supply. Longevity (how long one actually lives) “defines” demand; wealth (retirement resources broadly defined) “defines” supply. As noted above, setting aside any legacy objective, a goal, in accordance with one embodiment of the invention, is to make post-retirement wealth last over the individual's post-retirement life. That is, to make sure demand and supply are in equilibrium.

As discussed above, accelerating retirement age generally results in (1) a longer post-retirement period and thus greater demand and (2) a reduction in the supply of wealth—after earlier retirement the individual is no longer earning wages that can be saved. Conversely, deferring retirement age generally results in (1) a shorter post-retirement period and thus a decrease in demand and (2) an increase in the supply of wealth, funded out of the wages the individual continues to earn. Thus, decisions about retirement age affect both sides of the equation.

In tackling one basic question—“At what age will I have enough money to retire?”—longevity is considered, or as we think of it, retirement demand. At its simplest, the question is: “How long does my money need to last?” We relativize this question to the individual's retirement age decision: what is the participant's post-retirement life expectancy at different retirement ages?

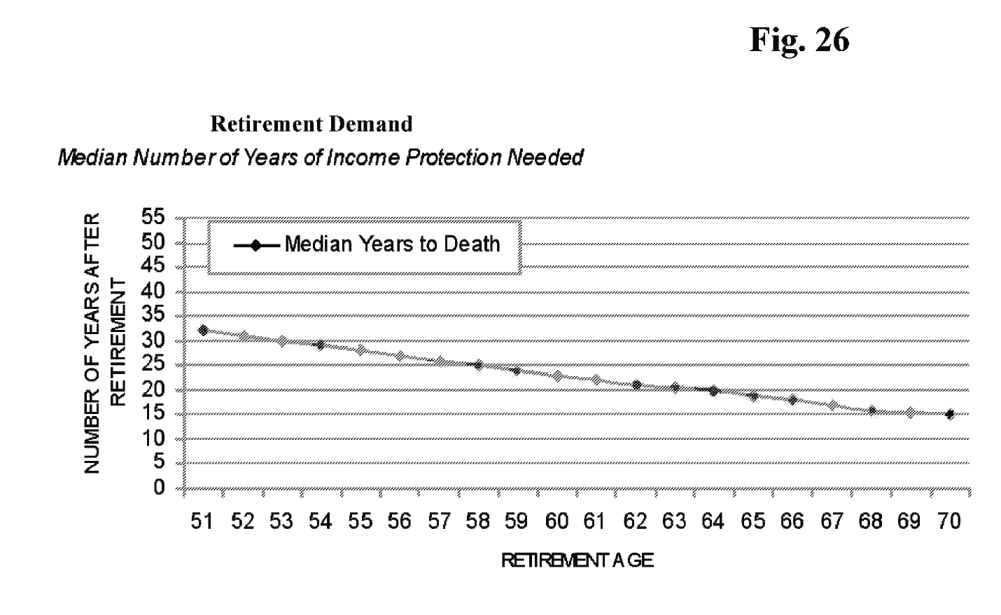

FIG. 26 is a graph the median life expectancy of a 50 year old man at different retirement ages, in accordance with one embodiment of the invention.

The curve depicted in FIG. 26 represents the median expected period of post-retirement survival. Half the population of retirees will have above-average survival. Accordingly, consideration should be taken of the contingency that survival will exceed the average.

If retirement is accelerated, the post-retirement period gets bigger; if retirement is deferred, the post-retirement period gets smaller. Or, using the framework, demand for retirement assets increases or decreases.

These numbers can, and should be, fine-tuned for certain individual situations. Health issues, where relevant, should also be considered. If one is planning for a couple, joint life expectancy will have to be considered and a decision will have to be made about retirement income goals both for the couple and the survivor.

A further variable is wealth. As we think of it, wealth defines retirement “supply.” When discussing demand, we asked “How long does my money need to last?” When looking at supply, we reverse the question (i.e., look at the other side of the “demand=supply” equation): “How long will the money that I have last?” And we relativize this question to the individual's retirement age decision.

In accordance with one aspect of the invention, we define wealth broadly. It may include, for instance, both assets and other retirement resources (e.g., pension and Social Security benefits). Moreover, our focus is not so much on “how much” wealth an individual has as “how long it will last.” So lifestyle and post-retirement lifestyle decisions are, in effect, variables affecting our wealth number.

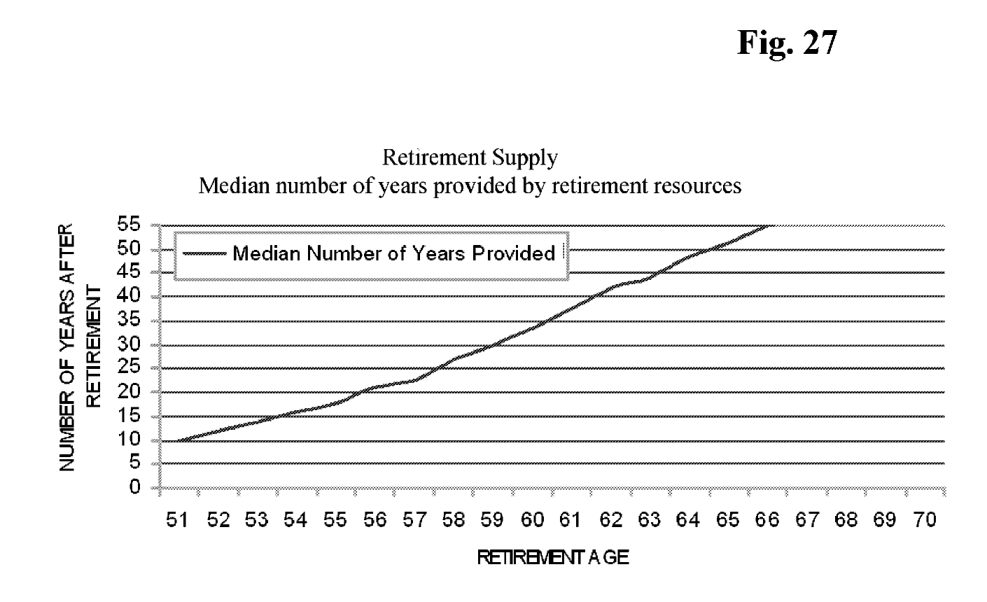

FIG. 27 is a graph of the median number of years “supply” of wealth will last at different retirement ages, in accordance with one embodiment of the invention. In this simplified example, we assume an individual age 50; earning $75,000 per year; with $600,000 in a 401(k) plan; contributing 6 percent of salary per year to that plan, on a pre-tax basis. We assume a 50/50 fixed income/equity asset allocation, where returns are based on stochastic modeling and capital markets assumptions with respect to returns, standard deviations and asset class correlations. Our assumptions on average produce a fixed income rate of return of 5.3 percent per year; an equity rate of return of 8.8 percent; and a 50/50 fixed income/equity allocation return of 7 percent. In determining the “supply” of retirement assets, we consider both 401(k) plan balances and Social Security benefits.

In this example we have assumed a lifestyle post-retirement that is generally 100 percent of pre-retirement lifestyle (inflation protected), after adjustments for changes in taxes and discontinuance of savings. Any of these supply assumptions can be modified without affecting the integrity of the analysis.

Hereinafter, the relationship between retirement age and supply will be described in accordance with one aspect of the invention. Deriving retirement wealth (“supply”) depends, much more so than deriving life expectancy, on individual circumstances. Critically, it depends not just on how much money an individual has now but on what future savings and future investment returns can be expected. Deferral of retirement increases the savings period and increases the principle on the basis of which future returns are projected.

Put concretely, each year that retirement is deferred three things happen:

1. Existing savings, that would otherwise be paid out as retirement income, accrue returns.

2. The individual can add, out of new wages, additional savings.

3. The value of other sources of retirement income, including Social Security and any defined benefit pension plan in which the individual participates, increases. In addition, during the deferral period the individual's pay may increase, “leveraging up” the wealth increases the items described in 1-3.

The analysis as performed by the financial calculation system 100, may fine tune supply inputs. That is, in this example, there is limited complexity. However, the analysis can accommodate all factors that affect supply:

1. Any other assets that can be used to provide for retirement, including: the client's home and other real estate; life insurance; and inherited wealth.

2. Lifestyle and lifestyle adjustments, including: alternative spend-down patterns (e.g., for a couple, different approaches to the first-to-die event); and a bottom-up post-retirement budget analysis.

3. Alternative pre-tax and post-tax analyses (e.g., with respect to different possible residences).

4. The use of annuities.

These and other factors can be integrated into the decision framework as implemented by the financial calculation system 100.

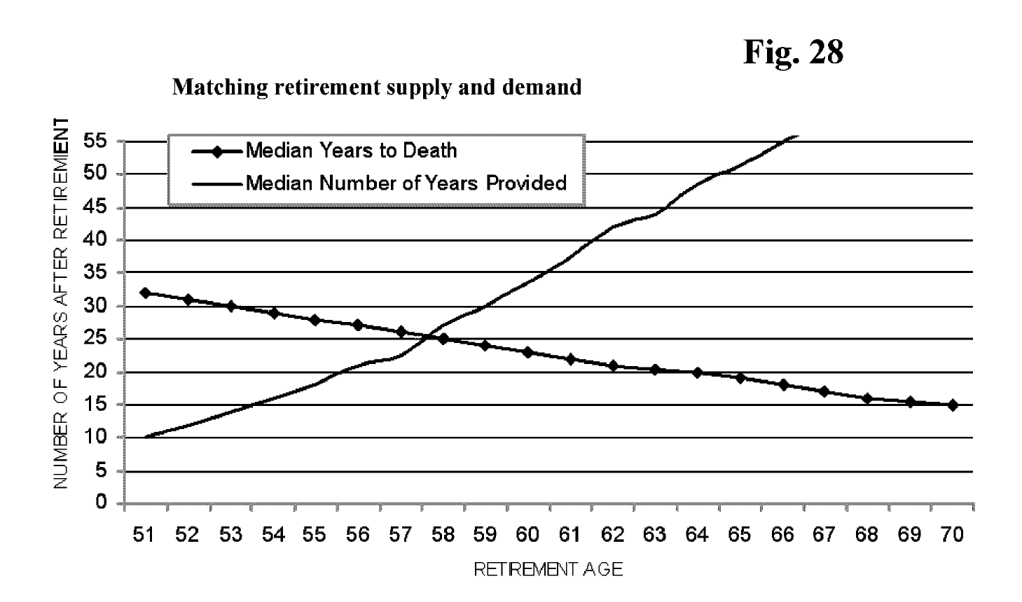

FIG. 28 is a further graph comparing supply and demand in accordance with one embodiment of the invention. Assuming our 50-year old lives to an average age and his wealth lasts an average period—the client in this example can retire at 57½, and, on average (or more technically, at the median), can expect his “supply” of wealth to last for the “demand” of his life expectancy. That approach, however, puts a lot of weight on “average” results. The client is at risk if his life expectancy over performs or his wealth underperforms the average.

Hereinafter, increasing the probability of a successful retirement will be described. Of a thousand individuals with characteristics identical to those in our example, half will have a “successful retirement”—that is, their retirement wealth will last for the period of their retirement demand—and half won't. Many clients (perhaps most) will be uncomfortable with those odds.

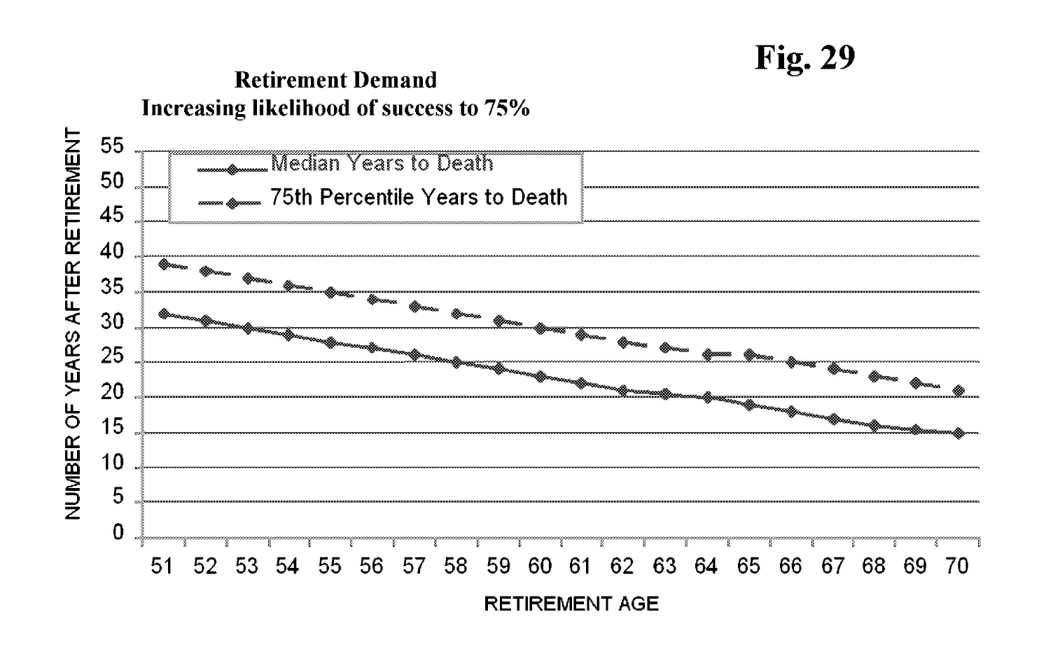

For decision making purposes, increasing the probability of success means, first, “covering” more years on the demand side (that is, in effect, assuming the individual will live longer than the median). FIG. 29 is a graph showing aspects of probability of success relating to demand, in accordance with one embodiment of the invention. That is, FIG. 29 shows, for our example individual, the original (median) demand line and a new demand line that targets a 75 percent probability of success. Increasing the probability of success with respect to supply means adjusting the expectation of how many post-retirement years the client's wealth will last. In accordance with one aspect of the invention, this change does not involve a change to, for instance, a more conservative investment strategy. Rather, it is a change to more conservative expectations. To enhance the probability of success, we assume our supply of wealth will cover fewer years. For instance (all other things being equal, and at the risk of stating the obvious), it is more probable that a given amount of wealth, however it is invested, will last 10 years than it is that it will last 15 years. Our analytical framework quantifies this probability—the “supply” line in the graph of FIG. 29, as generated by the financial calculation system 100 in accordance with one embodiment of the invention, maps it—and allows the client to decide what level of probability he or she is comfortable with.

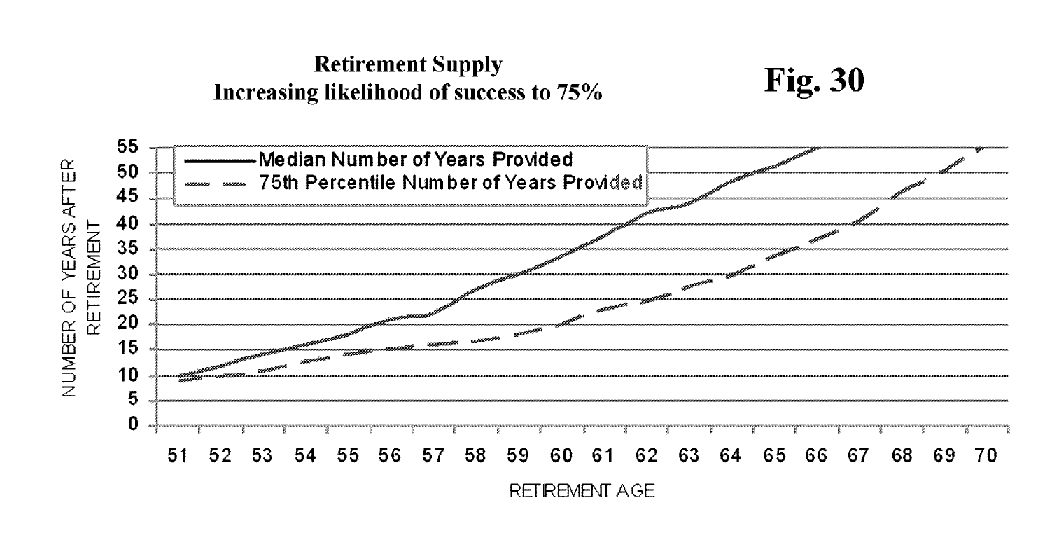

FIG. 30 is a graph showing aspects of probability of success relating to retirement supply, in accordance with one embodiment of the invention. That is, FIG. 29 shows, for our example individual, the original (median) supply line and a new supply line that targets a 75 percent probability of success.

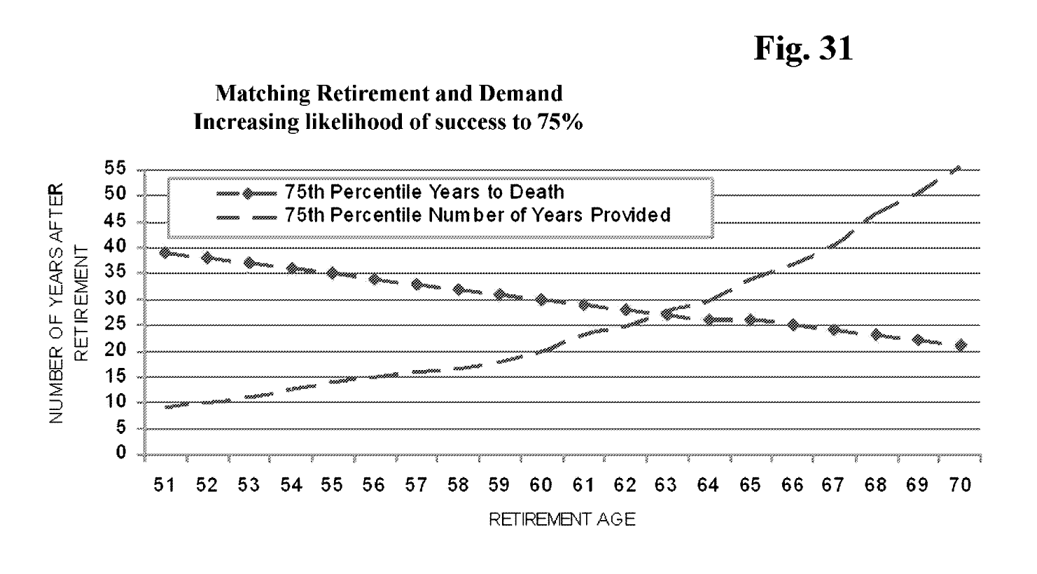

FIG. 31 is a graph showing the plotting of the adjusted demand curve and supply curve, in accordance with one embodiment of the invention. That is, FIG. 31 combines the adjusted demand curve of FIG. 29 and the adjusted supply curve of FIG. 30 to provide a solution for a new, “more successful” retirement age. Accordingly, in our original example, a 50 year old who retires at age 57½ has a 50 percent probability of a successful retirement, that is, a 50 percent chance that his wealth will last for the remainder of his life. If, however, he retires at age 63, he has a 75 percent probability of success.

The above illustrations take into account illustrative parameters and case scenarios. However, it is of course appreciated that such processing as described above may be varied to adjust for a wide variety of scenarios and parameters. For example, the processing may be adjusted to reflects parameters related to adding a spouse, different retirement plans, and/or any of a wide variety of other variations.

The processing as described herein and performed by the financial calculation system 100 may utilize batch processing of data (i.e., meaning that all the data to be used in the calculation is assembled and thereafter the processing is performed) or alternatively, the processing might be performed in real time, i.e., as revised data is entered, the calculation processing portion module 140 updates the generated/displayed results based on such updated data.

Hereinafter, general aspects of implementation of the systems and methods of the invention will be described.

As described above, and shown in the drawings, the disclosure sets forth various aspects of the methods and systems of the invention. The system of the invention or portions of the system of the invention may be in the form of a tangibly embodied “processing machine,” such as a general purpose computer of a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine.

The processing machine and/or processor executes the set of instructions/instructions that are stored in the memory or memories in order to process data. The set of instructions/instructions may include various instructions that perform a particular task or tasks, such as any of those tasks, i.e., processes, described herein and/or shown in the drawings. Such a set of instructions for performing a particular task may be characterized as a program, software program, or simply software, for example.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1-16. (canceled)

17. A method for performing retirement readiness financial calculation processing for a user, comprising:
in an information processing apparatus including at least a memory, a communication interface, and one or more computer processors:
receiving, via the communication interface, financial information for a user, the financial information comprising an identification of a plurality of assets;
the one or more computer processors determining an anticipated age of death for the user;
the one or more computer processors determining a pre-retirement financial lifestyle for the user;
the one or more computer processors determining a target post-retirement financial lifestyle for the user;
the one or more computer processors forecasting a future value of each of the plurality of assets;
based on the financial information, the anticipated age of death, the pre-retirement financial lifestyle, and the post-retirement financial lifestyle, the one or more computer processors determining an order and timing of a spend down of the plurality of assets to either reduce a probability of running out of assets at the anticipated age of death or maximize an amount of assets at the anticipated age of death;
presenting the order and timing of the spend down of assets to the user; and
the one or more computer processors executing the spend down of the plurality of assets in accordance with the order and timing.

18. The method of claim 17, wherein the plurality of assets comprise at least one of investments, real estate, and savings.

19. The method of claim 17, further comprising:
the one or more computer processors determining a retirement age for the user;
where the order and timing of the spend down of the plurality of assets is further based on the retirement age of the user.

20. The method of claim 17, wherein the pre-retirement lifestyle is based on an amount of income before the user retires.

21. The method of claim 17, wherein the post-retirement lifestyle is based on an amount of income after the user retires.
